(19) United States
(12) Patent Application Publication
(10) Pub. No.: US 2009/0168730 A1
(43) Pub. Date: Jul. 2, 2009

(54) Pilot Signal Allocation Method and Apparatus

(75) Inventors: Kevin L. Baum, Rolling Meadows, IL (US); Brian K. Classon, Palatine, IL (US); Vijay Nangia, Algonquin, IL (US)

Correspondence Address: MOTOROLA INC, 600 NORTH US HIGHWAY 45, W4 - 39Q, LIBERTYVILLE, IL, 60048-5343, US

(73) Assignee: Motorola, Inc., Schaumburg, IL (US)

(21) Appl. No.: 12/260,516

(22) Filed: Oct. 29, 2008

Related U.S. Application Data
(60) Provisional application No. 60/983,388, filed on Oct. 29, 2007.

(51) Int. Cl. H04J 3/00

(52) U.S. Cl. 370/336

(57) ABSTRACT

A pilot (or reference) transmission scheme is utilized where different transmitters are assigned pilot sequences with possibly different cyclic time shifts and different base pilot sequences. A pilot signal is transmitted concurrently by the transmitters in a plurality of pilot blocks, and a receiver processes the plurality of received pilot blocks to recover a channel estimate for at least one of the transmitters while suppressing the interference due to the pilot signals from the other transmitters.

### FIELD OF THE DISCLOSURE

The present invention relates generally to pilot signal allocation, and in particular to a method and apparatus for pilot signal allocation in a communication system.

### BACKGROUND OF THE DISCLOSURE

A pilot signal (or reference signal) is commonly used for communication systems to enable a receiver to perform a number of critical functions, including but not limited to, the acquisition and tracking of timing and frequency synchronization, the estimation and tracking of desired channels for subsequent demodulation and decoding of the information data, the estimation and monitoring of the characteristics of other channels for handoff, interference suppression, etc. Several pilot schemes can be utilized by communication systems, and typically comprise the transmission of a known sequence at known time intervals. A receiver, knowing the sequence only or knowing the sequence and time interval in advance, utilizes this information to perform the abovementioned functions.

For the uplink of future broadband systems, single-carrier based approaches with orthogonal frequency division are of interest. These approaches, particularly Interleaved Frequency Division Multiple Access (IFDMA) and its frequency-domain related variant known as DFT-Spread-OFDM (DFT-SOFDM), are attractive because of their low peak-to-average power ratio (PAPR), frequency domain orthogonality between users, and low-complexity frequency domain equalization.

In order to retain the low PAPR property of IFDMA/DFT-SOFDM, only a single IFDMA code should be transmitted by each user. This leads to restrictions on the pilot symbol format. In particular, a time division multiplexed (TDM) pilot block should be used, where data and pilots of a particular user are not mixed within the same IFDMA block. This allows the low PAPR property to be preserved and also enables the pilot to remain orthogonal from the data in multi-path channels, since there is conventionally a cyclic prefix between blocks. An example is shown in FIG. 1, where an IFDMA pilot block and subsequent IFDMA data blocks for a transmission frame or burst are shown.

Different pilot signals can be obtained by using different root base sequences, different cyclic shifts, and different time-domain block orthogonal codes between the pilot signals and the combination thereof. However, there are a limited number of separable pilot signals available for use by different transmitters in the system. Therefore a need exists for a method and apparatus for allocating pilot signals to different transmitters in the system while reducing and randomizing interference in the system.

The various aspects, features and advantages of the disclosure will become more fully apparent to those having ordinary skill in the art upon careful consideration of the following Detailed Description thereof with the accompanying drawings described below. The drawings may have been simplified for clarity and are not necessarily drawn to scale.

### BRIEF DESCRIPTION OF THE DRAWINGS

FIG. 1 illustrates data blocks and a pilot block in an IFDMA system or a DFT-SOFDM system.

FIG. 2 is a block diagram of a communication system that utilizes pilot transmissions.

FIG. 3 illustrates multiple subcarrier use in an IFDMA system or a DFT-SOFDM system.

FIG. 4 shows a burst format with pilot blocks and data blocks.

FIG. 5 shows a time-frequency example of transmissions in the burst format of FIG. 4.

FIG. 6 illustrates the channel responses of multiple transmitters with different cyclic time shifts of their pilot transmission in accordance with some embodiments of the invention.

FIG. 7 is a block diagram of an IFDMA transmitter.

FIG. 8 is a block diagram of a DFT-SOFDM transmitter.

FIG. 9 is a block diagram of a receiver.

FIG. 10 is a flow chart of a receiver.

FIG. 11 is a flow chart of a transmitter.

FIG. 12 is a flow chart of a method.

FIG. 13 is a block diagram of a controller.

FIG. 14 shows an example for pilot sequence allocation to different sectors of a cell.

FIG. 15 illustrates different cyclic time shifts used by transmitters for their pilot transmission.

FIG. 16 shows a typical sequence reuse pattern for the communication system of FIG. 2.

FIG. 17 shows a typical sequence reuse pattern for the communication system of FIG. 2.

FIG. 18 shows a typical sequence reuse pattern for the communication system of FIG. 2 with different pilot block time offsets.

FIG. 19 shows a transmission format with pilot blocks, data blocks and sounding block.

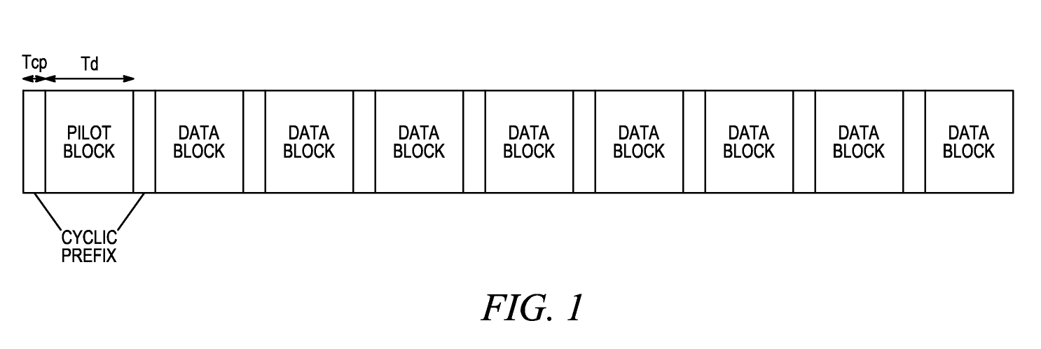

### DETAILED DESCRIPTION

To address the above-mentioned need, a method and apparatus for pilot or reference signal allocation is disclosed herein. In particular, a pilot (or reference) allocation scheme is utilized where different transmitters are assigned pilot sequences with possibly different cyclic time shifts and possibly different block orthogonal codes over a plurality of pilot blocks. A pilot signal is transmitted concurrently by the transmitters in a plurality of pilot blocks, and a receiver processes the plurality of received pilot blocks to recover a channel estimate for at least one of the transmitters while suppressing the interference due to the pilot signals from the other transmitters.

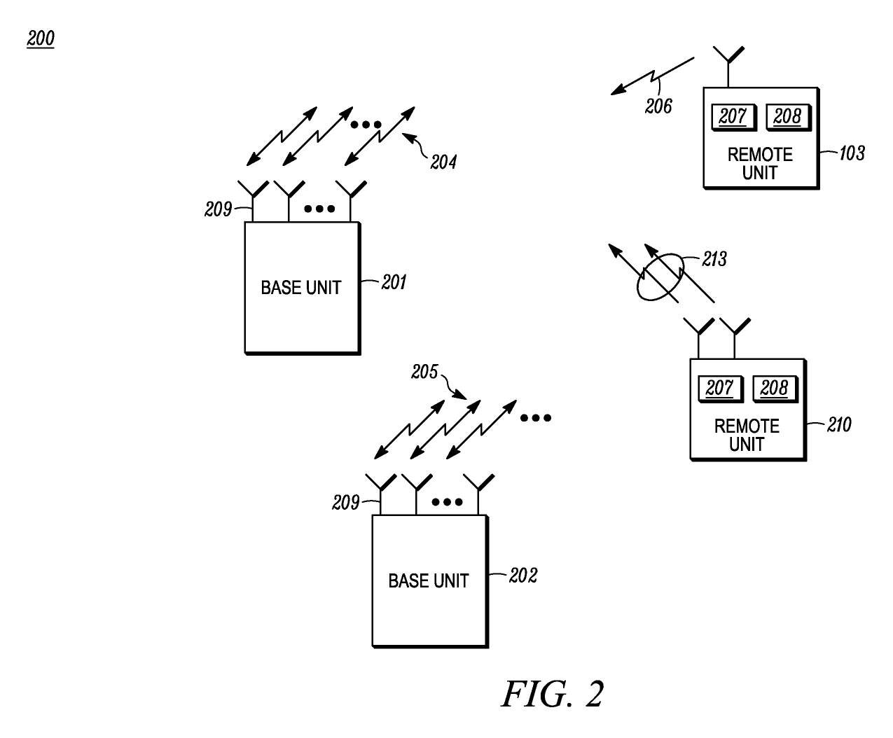

Turning now to the drawings, where like numerals designate like components, FIG. 2 is a block diagram of communication system 200 that utilizes pilot transmissions. Communication system 200 preferably utilizes either OFDMA or a next generation single-carrier based FDMA architecture for uplink transmissions 206, such as interleaved FDMA (IFDMA), Localized FDMA (LFDMA), DFT-spread OFDM (DFT-SOFDM) with IFDMA or LFDMA. While these can be classified as single-carrier based transmission schemes with a much lower peak-to average power ratio than OFDM, they can also be classified as multicarrier schemes in the present invention because they are block-oriented like OFDM and can be configured to occupy only a certain set of “subcarriers” in the frequency domain like OFDM. Thus IFDMA and DFT-SOFDM can be classified as both single-carrier and multicarrier since they have single carrier characteristics in the time domain and multicarrier characteristics in the frequency domain. On top of the baseline transmission scheme, the architecture may also include the use of spreading techniques such as direct-sequence CDMA (DS-CDMA), multi-carrier CDMA (MC-CDMA), multi-carrier direct sequence CDMA (MC-DS-CDMA), Orthogonal Frequency and Code Division Multiplexing (OFCDM) with one or two dimensional spreading, or simpler time and/or frequency division multiplexing/multiple access techniques, or a combination of these various techniques.

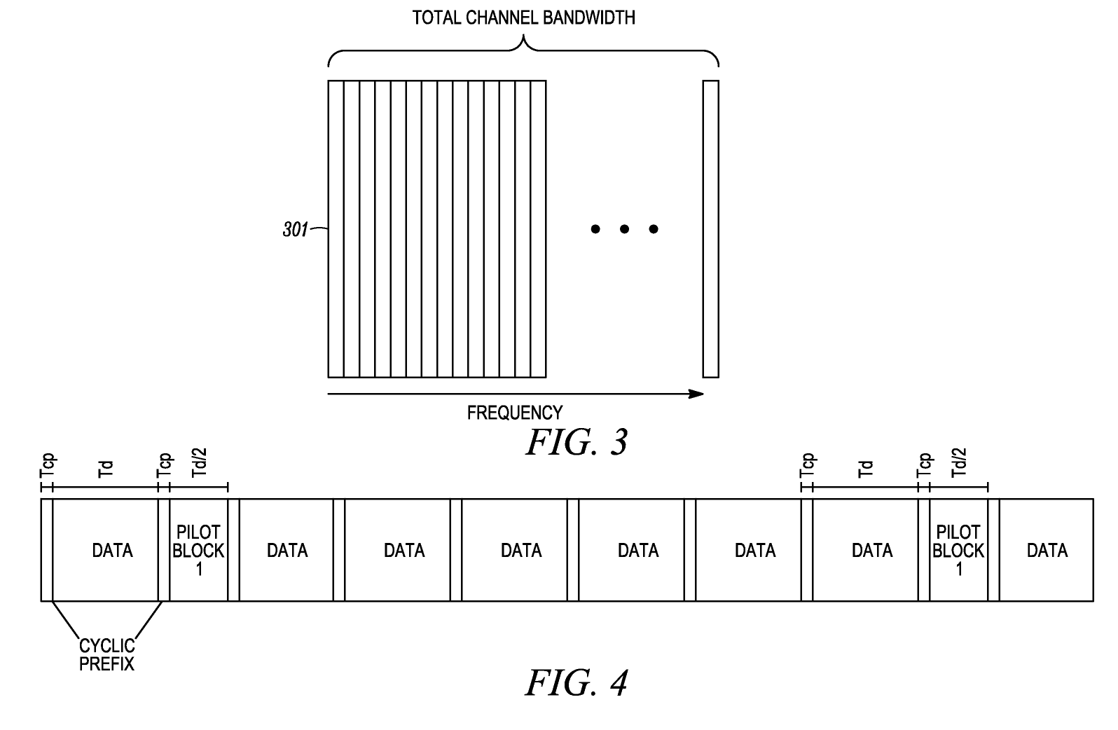

As one of ordinary skill in the art will recognize, even though IFDMA and DFT-SOFDM can be seen as single-carrier-based schemes, during operation of an IFDMA system or a DFT-SOFDM system, multiple subcarriers (e.g., 600 subcarriers) are utilized to transmit data. This is illustrated in FIG. 3. As shown in FIG. 3 the wideband channel is divided into many narrow frequency bands (subcarriers) 301, with data being transmitted in parallel on subcarriers 301. However, a difference between OFDMA and IFDMA/DFT-SOFDM is that in OFDMA each data symbol is mapped to a particular subcarrier, whilst in IFDMA/DFT-SOFDM a portion of each data symbol is present on every occupied subcarrier (the set of occupied subcarriers for a particular transmission may be a either a subset or all of the subcarriers). Hence in IFDMA/DFT-SOFDM, each occupied subcarrier contains a mixture of multiple data symbols.

Returning to FIG. 2, communication system 200 includes one or more base units 201 and 202, and one or more remote units 203 and 210. A base unit comprises one or more transmitters and one or more receivers that serve a number of remote units within a sector. The number of transmitters may be related, for example, to the number of transmit antennas at the base unit. A base unit may also be referred to as an access point, access terminal, Node-B, or similar terminologies from the art. A remote unit comprises one or more transmitters and one or more receivers. The number of transmitters may be related, for example, to the number of transmit antennas at the remote unit. A remote unit may also be referred to as a subscriber unit, a mobile unit, user equipment, a user, a terminal, a subscriber station, a user equipment, a user terminal or similar terminologies from the art. As known in the art, the entire physical area served by the communication network may be divided into cells, and each cell may comprise one or more sectors. When multiple antennas 209 are used to serve each sector to provide various advanced communication modes (e.g., adaptive beamforming, transmit diversity, transmit SDMA, and multiple stream MIMO transmission, etc.), multiple base units can be deployed. These base units within a sector may be highly integrated and may share various hardware and software components. For example, all base units co-located together to serve a cell can constitute what is traditionally known as a base station. Base units 201 and 202 transmit downlink communication signals 204 and 205 to serving remote units on at least a portion of the same resources (time, frequency, or both). Remote units 203 and 210 communicate with one or more base units 201 and 202 via uplink communication signals 206 and 213.

It should be noted that while only two base units and two remote units are illustrated in FIG. 2, one of ordinary skill in the art will recognize that typical communication systems comprise many base units in simultaneous communication with many remote units. It should also be noted that while the present invention is described primarily for the case of uplink transmission from a mobile unit to a base station, the invention is also applicable to downlink transmissions from base stations to mobile units, or even for transmissions from one base station to another base station, or from one mobile unit to another. A base unit or a remote unit may be referred to more generally as a communication unit.

As discussed above, pilot assisted modulation is commonly used to aid in many functions such as channel estimation for subsequent demodulation of transmitted signals. With this in mind, mobile unit 203 transmits known (pilot) sequences at known time intervals as part of their uplink transmissions. Any base station, knowing the sequence and time interval, utilizes this information in demodulating/decoding the transmissions. Thus, each mobile/remote unit within communication system 200 comprises pilot channel circuitry 207 that transmits one or more pilot sequences along with data channel circuitry 208 transmitting data.

For pilot signal transmission, a TDM pilot approach is attractive for PAPR and for providing orthogonality between the pilot and data streams. However, in some systems it may limit the granularity available for adjusting the pilot overhead. In one embodiment, a shorter block duration is used for the pilot block than for the data block in order to provide a finer granularity for the choice of pilot overhead. In other embodiments, the pilot block may have the same duration as a data block, or the pilot block may have a longer duration than a data block.

As a consequence of using a shorter block length for pilot blocks than data blocks, the subcarrier bandwidth and the occupied subcarrier spacing for the pilot block becomes larger than the subcarrier bandwidth and the occupied subcarrier spacing for the data block, assuming the same IFDMA repetition factor (or occupied subcarrier decimation factor) is used for both the pilot block and the data block. In this case, if the pilot block length (excluding cyclic prefix) is Tp and the data block length (excluding cyclic prefix) is Td, the subcarrier bandwidth and the occupied subcarrier spacing for the pilot block is Td/Tp times the subcarrier bandwidth and the occupied subcarrier spacing for the data block, respectively.

Pilot transmissions may occur simultaneously by two or more transmitters, such as mobile unit 203 and mobile unit 210, or by two or more antennas of mobile unit 210. It is advantageous to design the pilot sequences transmitted by different transmitters to be orthogonal or otherwise separable to enable accurate channel estimation by a receiver, such as base unit 201, to each transmitter (note that the role of the base units and mobile units may also be reversed, wherein the base units or antennas of a base unit are transmitters and the mobile unit or units are receivers).

One method of providing separability between the pilots or channel estimates of two or more transmitters is to assign different sets of subcarriers to different transmitters for the pilot transmissions, also referred to as FDMA pilot assignment. The different sets of subcarriers could be interleaved among transmitters or could be on different blocks of subcarriers, and may or may not be confined to a small portion of the channel bandwidth of the system.

Another method of providing separability between the pilots or channel estimates of multiple transmitters is to assign two or more transmitters to a same set of subcarriers for pilot transmission and utilize sequence properties to provide the separability. Note that FDMA pilot assignments and the utilization of sequence properties can both be applied to a system. For example, a first set of transmitters may use a first set of subcarriers, with each transmitter in the set transmitting its pilot signal on possibly all of the subcarriers of the first set of subcarriers. A second set of transmitters may use a second set of subcarriers for pilot transmission, where the second set of subcarriers is orthogonal to the first set of subcarriers (FDMA). Note that the members of a set of subcarriers do not need to be adjacent. Since the transmitters in a set may interfere with each other as they use the same set of subcarriers for pilot signal transmission, the pilot sequences of the transmitters in the same set should have sequence properties that enable the channel response to be estimated to one of the transmitters while suppressing the interference from the other transmitters in the same set. The present invention provides a method and apparatus for suppressing such interference.

The present invention enables a larger number of transmitters to transmit pilot signals simultaneously while providing for separability of the pilots or channel estimates at a receiver. Multiple transmitters transmit pilots on a first set of subcarriers during a first interval (e.g., a first pilot block), and the multiple transmitters transmit pilots on a second set of subcarriers during a second interval (e.g., a second pilot block). The number of intervals or pilot blocks may also be larger or smaller than two. In the case where the number of intervals is two or more, the pilot sequence properties are chosen for a plurality of intervals to provide channel estimate separability over the plurality of intervals, even though the channel estimates may not be separable if only a single interval was considered.

A burst or sub-frame format suitable for use with one embodiment the invention is shown in FIG. 4. In FIG. 4, Td is the duration of a data block and the duration of the pilot block is Tp=Td/2. One way to specify the subcarriers assigned to or used by a signal is to specify the block length B, the repetition factor R (or the subcarrier decimation factor or skip factor), and the subcarrier offset index S. The parameters are similar to a B-subcarrier OFDM modulator, with subcarrier mapping of evenly-spaced subcarriers with spacing of R subcarriers with a subcarrier offset of S, for an DFT-SOFDM signal. These can be written as an ordered triplet: (B, R, S). In the example, the data blocks are configured as (Td, Rd, Sd). The first pilot block is configured as (Tp, Rp, Sp1) and the second pilot is configured as (Tp, Rp, Sp2). The cyclic prefix (CP) length is Tcp. Note that the block length, repetition factor, and subcarrier offset can in general be different for pilot blocks and data blocks, or can be changed over time for data blocks or pilot blocks.

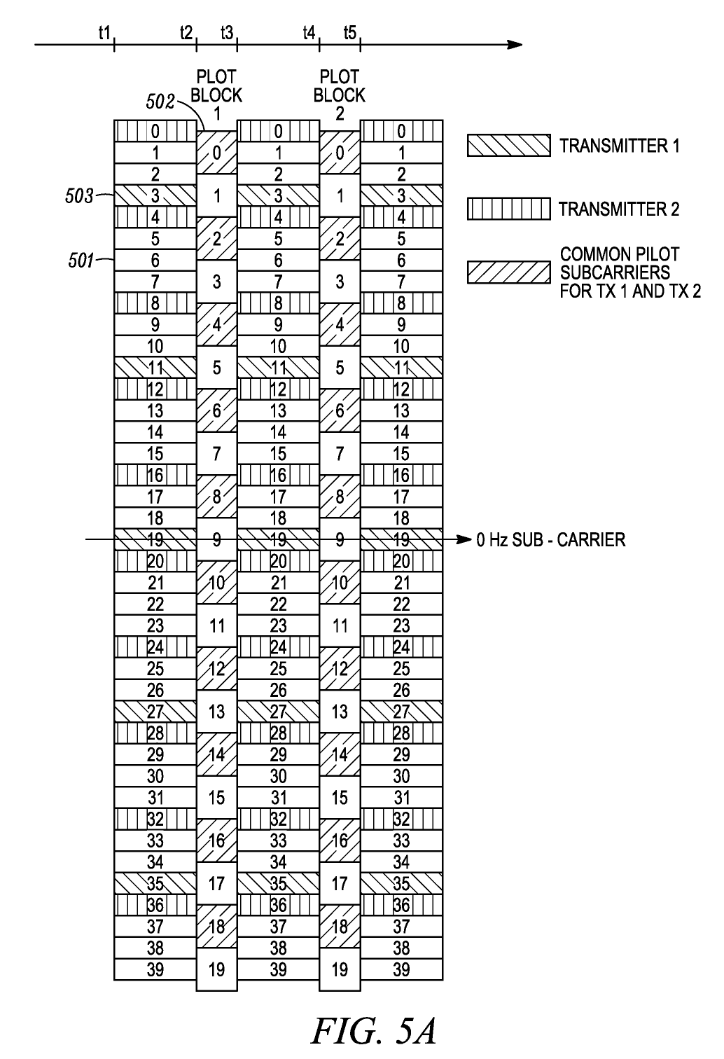

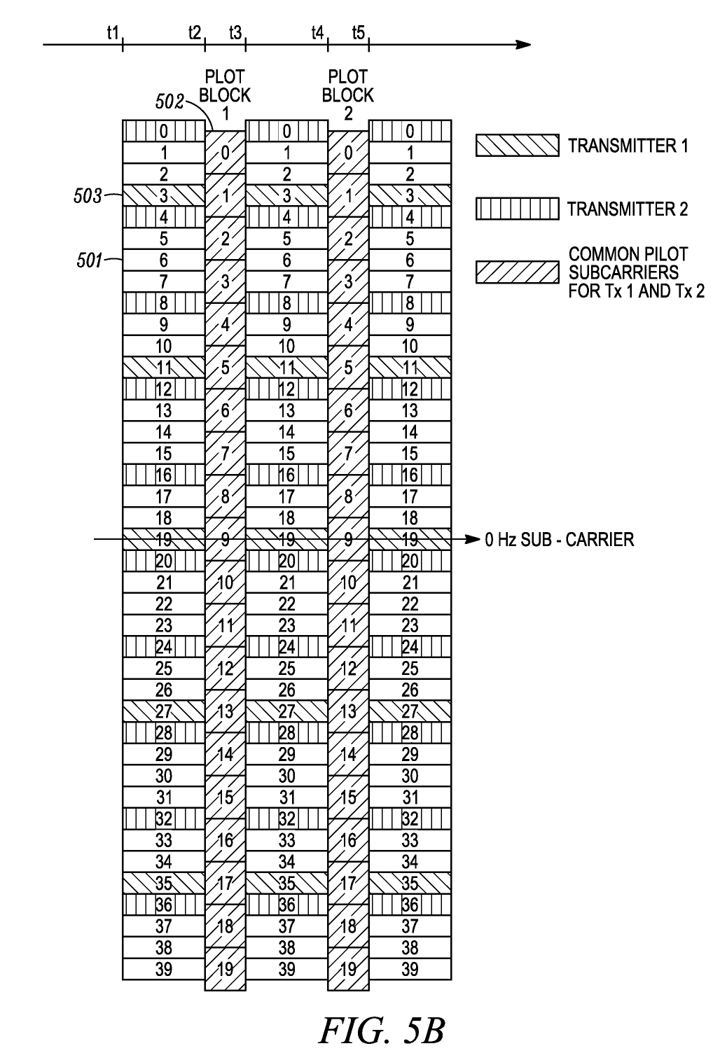

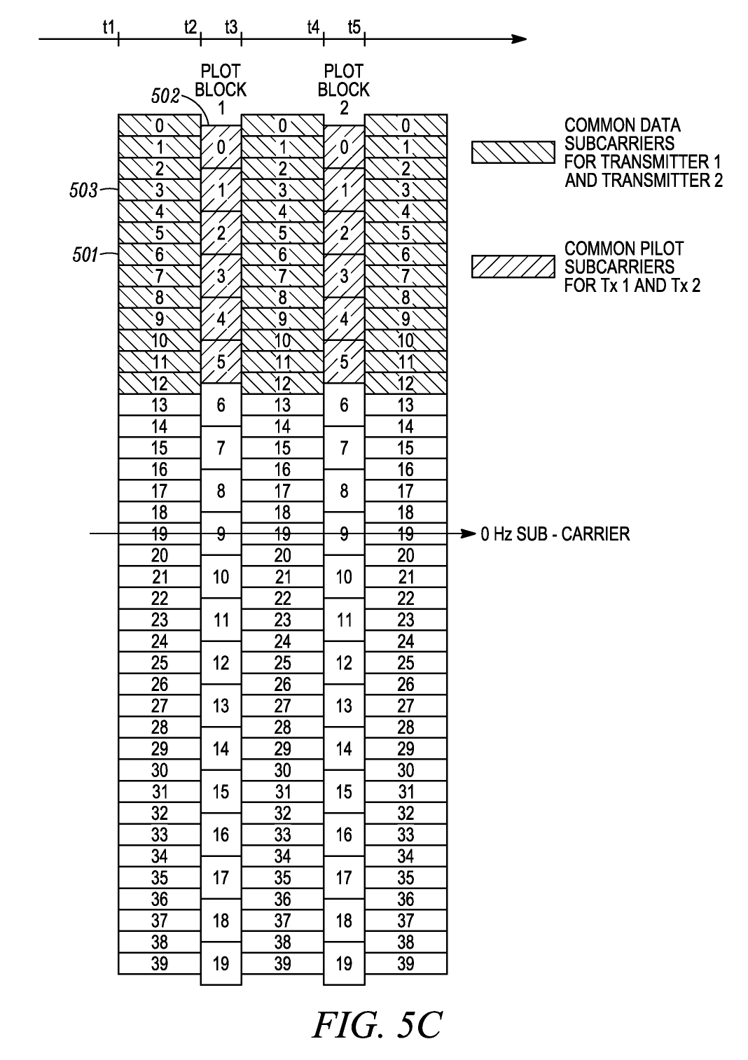

While FIG. 4 shows the time domain format of the burst, the frequency domain description over time is shown in FIG. 5. For simplicity, FIG. 5 shows pilot and data transmission for only two transmitters, with the transmissions by each transmitter being shaded. In FIG. 5A, the data blocks of the first transmitter are configured as (Td=66.67, Rd=8, Sd=3), the data blocks of the second transmitter are configured as (Td=66.67, Rd=4, Sd=0), the first pilot block (pilot set 1) is configured as (Tp=33.33, Rp=2, Sp=0) for both transmitters, and the second pilot block (pilot set 2) is configured as (Tp=33.33, Rp=2, Sp=0) for both transmitters. In FIG. 5B, the data blocks for the first and second transmitter are configured similarly to FIG. 5A, while both the first and second pilot blocks are configured as (Tp=33.33, Rp=1, Sp=0), thus providing pilot information on directly adjacent subcarriers of the pilot block. As one of ordinary skill in the art will recognize, transmissions by a particular transmitter (e.g., transmitter 1 in FIG. 5) will occupy several subcarriers, as indicated by the shaded subcarriers 503 (only one labeled) out of all the subcarriers 501 (only one labeled). FIG. 5 is illustrated having total possible data block subcarriers 0 through 39. Note that the data block configuration (Td, Rd, Sd) for a transmitter could be different on different data blocks within the burst. Also, the pilot block configuration could be different on different pilot blocks in the burst. While the example given in FIGS. 5A and 5B is for IFDMA of the data transmissions from different transmitters, note that LFDMA can also be represented by setting Rd=1, Td<=40, and by choosing Sd as the first occupied subcarrier of the transmitter's data transmission. This is shown in FIG. 5C for the case where the transmissions by both transmitters occupy the same 12 data and 6 pilot subcarriers with the data blocks for both transmitter configured as (Td=66.67, Rd=1, Sd=0), while both the first and second pilot blocks are configured as (Tp=33.33, Rp=1, Sp=0), thus providing data and pilot information on directly adjacent subcarriers.

Because the pilot channel block duration is less than the data channel block duration in the burst format of FIG. 4, each pilot subcarrier 502 (only one labeled) takes up more bandwidth than does a data subcarrier. For example, in FIG. 5, a pilot subcarrier takes up twice as much bandwidth as a data subcarrier. Thus, fewer pilot subcarriers can be transmitted within the available bandwidth than can data subcarriers. FIG. 5 is illustrated having the total possible pilot subcarriers 0 through 19, with both transmitters occupying the shaded pilot subcarriers (the remaining unshaded data and pilot subcarriers can be utilized by other transmitters).

In one embodiment of the invention, cyclic time shifts of one or more pilot sequences are transmitted by mobile unit 203 and mobile unit 210 in the first pilot block and in the second pilot block of FIG. 5. A cyclic time shift of a pilot sequence can be implemented, for example, by moving a block of time domain samples of the pilot block from the end of the pilot block to the beginning of the pilot block. Then the cyclic prefix of the pilot block is based on the samples of the pilot block after the cyclic shift has been applied. The number of samples that are moved from the end of the block to the beginning of the block is the amount of the cyclic shift in the block. For the purpose of illustration, if there are six time domain samples in a particular pilot block and they are, in time order from first to last, x(1), x(2), x(3), x(4), x(5), x(6), then a cyclic time shift of three samples would result in a pilot block with the samples, in time order from first to last, of x(4), x(5), x(6), x(1), x(2), x(3). And if the cyclic prefix for the pilot block was two samples, the cyclic prefix samples of the cyclically shifted pilot block would be, from first to last, x(2), x(3). As will be described later, there are additional methods for providing a cyclic time shift that are equivalent to the one described above.

When multiple transmitters are transmitting pilot blocks simultaneously on the same set of subcarriers, different transmitters can use different cyclic time shifts of the same pilot sequence to enable a receiver to estimate the channel between the receiver and each of the transmitters. For the purpose of illustration, assume that the first transmitter is using a first pilot sequence that has constant magnitude, when viewed in the frequency domain, on the subcarriers used by the pilot block. Also assume the pilot block length is Tp and the cyclic prefix length is Tcp. If the channel impulse response duration is less than or equal to Tcp and the pilot block has Rp=1 (as shown in FIGS. 5B and 5C), then it can be shown that up to Tp/Tcp different transmitters can transmit in the same pilot block, with different cyclic shift values, and the channel estimates will be separable (or nearly orthogonal) at the receiver. For example, if Tp/Tcp=4 and there are 4 transmitters, then a first transmitter can use a cyclic time shift of 0, a second transmitter can use a cyclic time shift of Tp/4, a third transmitter can use a cyclic time shift of Tp/2, and a third transmitter can use a cyclic time shift of 3Tp/4. In equation form, a frequency-domain representation of a pilot sequence for the l^{th} transmitter on subcarrier k and block b for the case of Rp=1 can be represented as: xₗ(k,b)=s(k,b)e^{-j2πkα}^{ₗ}^{/P} where s(k,b) is the base or un-shifted pilot sequence (e.g., a constant modulus signal such as QPSK, a CAZAC sequence, a GCL sequence, or the DFT/IDFT of a CAZAC or GCL sequence), αₗ is the cyclic time shift for transmitter l (for the example above α₁=0, α₂=Tp/4, α₃=Tp/2, and α₄=3Tp/4), and P is a cyclic shift factor (P=Tp in the above example). Note that the pilot sequence can be implemented in the time domain by performing a circular shift of S(n,b) which is the IFFT of s(k,b) (for the above example, transmitter 1 would send an unshifted version of S(n,b), transmitter 2 would send S(n,b) circularly shifted by Tp/4 samples, transmitter 3 would send S(n,b) circularly shifted by Tp/2 samples, and transmitter 4 would send S(n,b) circularly shifted by 3Tp/4 samples).

Note also that the equation representation of the frequency-domain pilot sequence given above is easily extended to the case where Rp≠1. In this case the pilot sequence is only defined on certain subcarriers and the subcarrier offset, S, must be added to the pilot sequence equation as follows (note that in the next equation Tₚ=Tp and Rₚ=Rp): xₗ(S+Rₚf,b)=s(S+Rₚf,b)e^{-j2πfα}^{ₗ}^{/P} f=0, 1, . . . , Tₚ/Rₚ−1Note that the values of αₗ and P may need to change based on the value of Rp. Also note that all subsequent equation representations of the pilot sequence will be given for Rp=1 but can be extended to Rp≠1 in a similar manner to what was just presented.

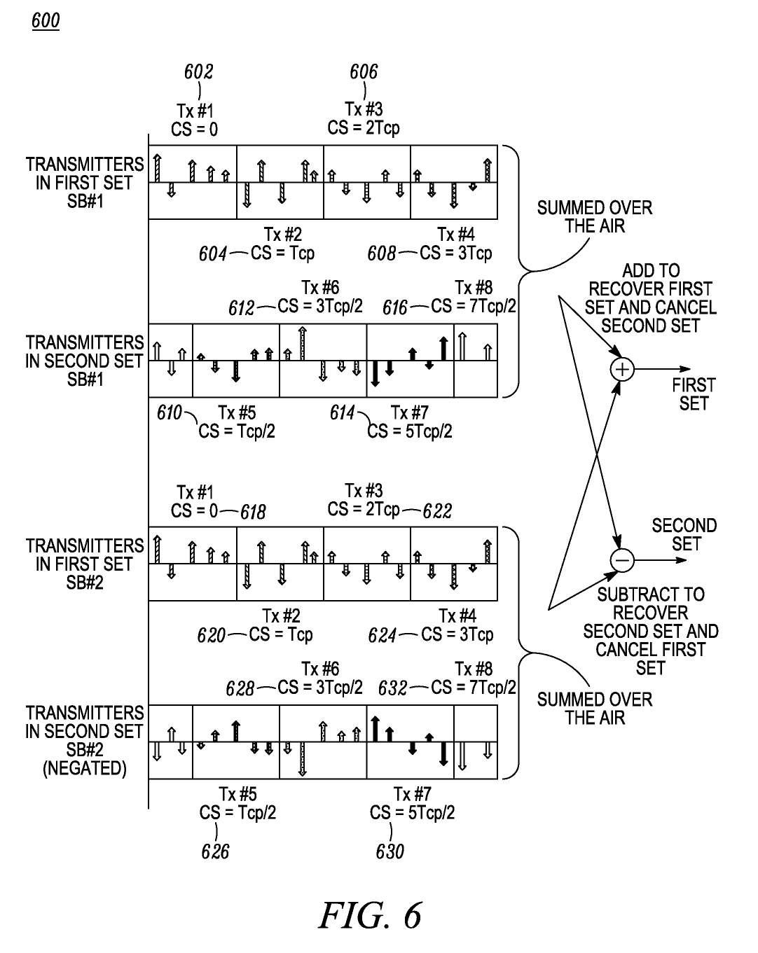

At the receiver, when the receiver correlates the original pilot sequence with the composite received pilot block from the four transmitters, the channel response to the first transmitter will be in a first block of Tp/4 correlator output samples, as shown in FIG. 6 602, the channel response to the second transmitter will be in the next block of Tp/4 correlator output samples, as shown in FIG. 6 604, and so forth, as shown in FIG. 6 606 and 608. (Note that the correlator-based channel estimator is only used as an example and other channel estimation techniques known in the art might be used such as DFT-based channel estimator and MMSE-based channel estimators.)

Note that in this example, the time shift increment of Tp/4 was chosen to be the same as the cyclic prefix (CP) duration (Tcp=Tp/4). It is often advantageous to make the time shift increment similar to the CP length if the pilot block has Rp=1 because the CP is normally chosen to be as large as the maximum expected multipath channel delay spread in the system 200 of FIG. 2. However, if Tcp is shorter than the expected duration of the channel for adequate channel response separability, then the number of transmitters that can be separated at the receiver is Tp/L where L is the expected maximum length or duration of the channel. In this case the time shift increment could be larger than the CP length and could be tied to the expected maximum channel length, L. When the CP length is at least as large as the multipath delay spread of the channel, then the channel responses for each transmitter will be confined to its respective correlator output block of length Tcp (note that practical issues such as conventional signal conditioning and filtering, sampling granularity, and so on will generally cause a small amount of leakage between the estimates of the channel response in one correlator output block and another, but in most cases of interest this leakage can be considered small and be ignored for the purpose of describing the invention). However, if the time shift increment between transmitters is less than the channel response duration, a portion of the channel response of one transmitter will appear in the channel response of another transmitter and will interfere with the channel estimate of the other transmitter. As a result, in this example, if the channel response is no larger than the CP length and the time shift increment between transmitters equal to the CP length (with Tcp=Tp/4), a total of four transmitters can be supported while providing separable channel estimates to each transmitter.

In order to increase the number of transmitters that can be supported with separable channel estimates, pilot sequences can be assigned to a plurality of transmitters over a plurality of pilot blocks, such that when processed over the plurality of pilot blocks at a receiver, the channel estimates become separable. This is illustrated in FIG. 6, which provides a doubling of the number of transmitters that can be supported with separable channel estimates. In one pilot block (denoted as SB#1 in FIG. 6), some of the transmitters in FIG. 6 are assigned cyclic shifts that are integer multiples of Tcp (multiples of 0, 1, 2, 3) and others are assigned cyclic shifts that are odd multiples of Tcp/2 (multiples 1, 3, 5, 7). For example, a first transmitter denoted as Tx#1 uses a first cyclic time shift value of zero, and the time domain channel response for this transmitter is illustrated by the five arrows or rays within the time region from 0 to Tcp in the region 602 associated with transmitter Tx#1. A second transmitter, denoted as Tx#5 in FIG. 6, uses a second cyclic time shift value of Tcp/2. As a result, when the channel response length for transmitter Tx#1 is greater than Tcp/2, the channel response for transmitter Tx#1 will interfere with the channel response for transmitter Tx#5 in the region between Tcp/2 and Tcp, and vice versa, and the channel estimates are no longer separable without significant interference. In equation form, a frequency-domain pilot sequence for the l^{th} transmitter on subcarrier k and block b₁ (which is the location of this first pilot block) for the case of Rp=1 can be represented as: xₗ(k,b₁)=s(k,b₁)e^{-j2πkα}^{ₗ}^{/P} where s(k,b₁) is a base pilot sequence for the first pilot block (e.g., a constant modulus signal such as QPSK, a CAZAC sequence, a GCL sequence, or the DFT/IDFT of a CAZAC or GCL sequence), αₗ is the cyclic time shift for transmitter l (for the example above α₁=0, α₂=Tcp, α₃₌₂Tcp, α₄=3Tcp, α₅=Tcp/2, α₆=3Tcp/2, α₇₌₅Tcp/2, α₈=7Tcp/2), and P is a cyclic shift factor (P=4Tcp in the above example). Note that as in the previous equation that these shifts can be applied in the time domain by circularly shifting the IFFT of s(k,b₁), S(n,b₁), by the appropriate amounts.

In order to provide separability with the larger number of transmitters, a second pilot block is transmitted by the transmitters. The channel responses associated with the transmitters for the second pilot block are illustrated in the lower half of FIG. 6 (SB#2). The pilot sequences of the transmitters are assigned in a way that allows the interference between the first transmitter and the second transmitter to be suppressed by combining the channel estimates from the first and second pilot blocks. In one embodiment, cyclic time shifts of a common pilot sequence are used in both the first and second pilot blocks, but the sign of the common pilot sequence is inverted in one of the pilot blocks for one or more transmitters. FIG. 6 shows that an embodiment where the sign of the pilot sequence is inverted during the second pilot block for transmitters using cyclic shifts that are odd multiples of Tcp/2. In equation form for this embodiment, a frequency domain representation of the pilot sequence for the l^{th} transmitter on subcarrier k and block b₂ (which is the location of this second pilot block) for the case of Rp=1 is given as:

$${x}_{l} ( k , {b}_{2} ) = \{ \begin{matrix}s ( k , {b}_{2} ) {e}^{- j 2 π k {α}_{l} / P} & for 1 \leq l \leq 4 \\ - s ( k , {b}_{2} ) {e}^{- j 2 π k {α}_{l} / P} & for 5 \leq l \leq 8\end{matrix}$$

where s(k,b₂) is a base or un-shifted pilot sequence for the second pilot block (e.g., a constant modulus signal such as QPSK, a CAZAC sequence, a GCL sequence, or the DFT/IDFT of a CAZAC or GCL sequence), αₗ is the cyclic time shift for transmitter % (for the example above α₁=0, α₂=Tcp, α₃₌₂Tcp, α₄=3Tcp, α₅=Tcp/2, α₆₌₃Tcp/2, α₇₌₅Tcp/2, α₈=7Tcp/2), and P is a cyclic shift factor (P=4Tcp in the above example). Note that as in the previous equations that these shifts can be applied in the time domain by circularly shifting the IFFT of s(k,b₂), S(n,b₂), by the appropriate amounts. This allows the interference between transmitters with odd multiples of Tcp/2 and transmitters with integer multiples of Tcp to be suppressed by combining over the received pilot blocks. Thus, the interference from transmitter Tx#5 on the channel estimate for Tx#1 can be suppressed adding the first received pilot block to the second received pilot block prior to performing channel estimation. Alternatively, a channel estimate derived for Tx#1 from the first pilot block can be added to a channel estimate derived for Tx#1 from the second pilot block to suppress the interference from Tx#5. Likewise, the interference from Tx#1 on Tx#8 can be suppressed by subtracting the second received pilot block from the first received pilot block prior to channel estimation, or the channel estimate obtained for Tx#8 in the second pilot block can be subtracted from the channel estimate obtained for Tx#8 in the first pilot block (this assumes that an inverted channel estimate is obtained for Tx#8 in the second pilot block by correlating with non-inverted common pilot sequence—however, if the inverted sequence is correlated with the second pilot block, then a non-inverted channel estimate would be obtained for Tx#8 and the estimates for Tx#8 from the first pilot block and the second pilot block would be added instead of subtracted). In the above example for the same assigned cyclic time shifts, if the channel response is no larger than Tcp/2 then the transmitters with assigned cyclic shifts that are odd multiples of Tcp/2 may not interfere with the transmitters with cyclic shifts integer multiples of Tcp on each pilot block. In this case the sign inversion of the pilot sequence during the second pilot block for transmitters using cyclic shifts that are odd multiples of Tcp/2 and combining of the received pilot blocks may provide improved averaging over other-cell interference.

Note that in the above description it was assumed that the second pilot block contained the negation. If the negation were to be applied to the first pilot block and no negation applied to the second pilot block, then similar processing to that described above could be used but with the roles of the first and second pilot blocks being reversed.

In another embodiment, cyclic time shifts of a first common (or base or un-shifted) pilot sequence are assigned to the transmitters for the first pilot block and cyclic shifts of a second, different, common (or base or un-shifted) pilot sequence, that is also inverted for some transmitters (as in the previous embodiment), is assigned to the transmitters for the second pilot block. This embodiment may provide improved averaging over other-cell interference. In this embodiment, the channel estimates for the first pilot block can be obtained by correlating the first received pilot block with the first common sequence, and the channel estimates for the second pilot block can be obtained by correlating the second received pilot block with the second common sequence. The channel estimates for the first and second pilot blocks can be combined (e.g., added or subtracted, as appropriate) to suppress the corresponding interference. In equation form for this embodiment, a frequency domain representation of the pilot sequence for the l^{th} transmitter on subcarrier k and symbol bₘ (which is the location of the m^{th} pilot block) can be represented as (for Rp=1): xₗ(k,bₘ)=sₘ(k,bₘ)e^{-j2πkα}^{ₗ}^{(b}^{ₘ}^{)/(P(b}^{ₘ}⁾ where sₘ(k,bₘ) is a base or un-shifted pilot sequence for the m^{th} pilot block (e.g., a constant modulus signal), αₗ(bₘ) is the cyclic time shift for transmitter l for pilot block m, and P(bₘ) is a cyclic shift factor for pilot block m. Note that the cyclic shift could also be implemented in the time domain by circularly shifting the time-domain pilot signal by the appropriate amount.

In another embodiment, one set of transmitters is assigned cyclic shifts of a first common pilot sequence for both the first and second pilot blocks, and a second set of transmitters is assigned cyclic shifts of a second common pilot sequence for both the first and second pilot blocks, but the second common sequence is inverted in the second pilot block relative to the second common sequence in the first pilot block so that the received pilot blocks can be processed to suppress the interference between transmitters assigned the same cyclic time shift value. In equation form for this embodiment, a frequency-domain representation of the pilot sequence for the l^{th} transmitter on subcarrier k and symbol bₘ (which is the location of the m^{th} pilot block, m=0, 1) can be represented as (for Rp=1):

$${x}_{l} ( k , {b}_{m} ) = \{ \begin{matrix}s ( k , {b}_{m} ) {e}^{- j 2 π k {α}_{l} / P} & for l ∈ {L}_{1} \\ {( - 1 )}^{m - 1} z ( k , {b}_{m} ) {e}^{- j 2 π k {α}_{l} / P} & for l ∈ {L}_{2}\end{matrix}$$

where L₁ is the first set of transmitters, L₂ is the second set of transmitters, s(k,bₘ) is a base or un-shifted pilot sequence for the first set of transmitters on pilot block m (e.g., a constant modulus signal), z(k,bₘ) is a base or un-shifted pilot sequence for the second set of transmitters on pilot block m (e.g., a constant modulus signal), αₗ is the cyclic time shift for transmitter l, and P is a cyclic shift factor.

In another embodiment, the cyclic time shift assigned to one transmitter can be the same as the cyclic time shift assigned to another transmitter (e.g., with 8 transmitters, two could be assigned a cyclic shift of 0, another two can be assigned a cyclic shift of Tcp, and so on). In this embodiment, cyclic time shifts of a common pilot sequence can be used by the transmitters in both the first and second pilot blocks, but the sign of the common pilot sequence is inverted in one of the pilot blocks for one set of transmitters so that the received pilot blocks can be processed to suppress the interference between transmitters assigned the same cyclic time shift value. In another embodiment where the same cyclic time shift is assigned to multiple transmitters, one set of transmitters, each with a different cyclic shift value, is assigned a first pilot sequence, and a second set of transmitters, each with a different cyclic shift value, is assigned a second pilot sequence. The transmitters in the second set invert the pilot second pilot sequence in one of the pilot blocks so that the received pilot blocks can be processed to suppress the interference between transmitters assigned the same cyclic time shift value.

Cyclic shift hopping: In another embodiment, a first cyclic time shift is assigned to a transmitter on the first pilot block and a different second cyclic time shift is assigned to the transmitter on the second pilot block. In this embodiment, the same or different base pilot sequence can be used on the first and second pilot blocks with the sign of the base pilot sequence inverted in one of the pilot blocks for one set of transmitters so that the received pilot blocks can be processed to suppress the interference between transmitters. The cyclic time shift offset (modulo the pilot block duration) between the first and second cyclic time shift may be the same for transmitters in both the first and second set of transmitters. For example, with a cyclic time shift offset of 2Tcp, the cyclic time shift for transmitter l, αₗ on the first pilot block is α₁=0, α₂=Tcp, α₃=2Tcp, α₄=3Tcp, α₅=Tcp/2, α₆=3Tcp/2, α₇=5Tcp/2, α₈=7Tcp/2 while on the second pilot block is α₁=0, α₂=Tcp, α₁=2Tcp, α₂=3Tcp, α₃=0, α₄=Tcp, α₅=5Tcp/2, α₆=7Tcp/2, α₇=Tcp/2, α₈=3Tcp/2. The cyclic time shift offset may be a function of the pilot block location within the sub-frame, sector/cell identification ID, sub-frame number, system frame number or a combination thereof.

For the convenience, the embodiments above have been described for the case where the pilot block has Rp=1 (e.g., FIGS. 5B and 5C). In embodiments where the pilot block transmission of a transmitter occupies a decimated set of subcarriers, such as an Rp=2 in FIG. 5A, the number of separable channel responses is reduced. The number of separable channel responses becomes (1/Rp) times the number of separable channel responses that were possible with Rp=1. For example, if FIG. 6 is for the case of Rp=1 on a pilot block, then for an embodiment similar to FIG. 6 but with Rp=2, there could be two transmitters in the first set, with cyclic shifts of 0 and Tcp respectively, and there could be two other transmitters in the second set, with cyclic shifts of Tcp/2 and 3Tcp/2 respectively.

For the convenience, the embodiments of the invention are described for the case where there are two pilot blocks over which the channel response separability is obtained. However, the invention is also applicable when the number of pilot blocks is greater than two. For example, one embodiment with four pilot blocks would provide for twice as many separable channel responses as an embodiment with two pilot blocks. Building upon FIG. 6, there may be four sets of transmitters, each set using a possibly different set of cyclic shifts. For example, a third set of transmitters could be assigned cyclic shifts of Tcp/4, 5Tcp/4, 9Tcp/4, or 13Tcp/4, and a fourth set of transmitters could be assigned cyclic shifts of 3Tcp/4, 7Tcp/4, 11Tcp/4, or 15Tcp/4. For embodiments with more than two pilot blocks, the sequence inversion method described earlier can be extended to the general case of orthogonal sets of multiplicative factors over the pilot blocks. For example, all transmitters can use cyclic shifts of a common pilot sequence, and the four pilot blocks of the first set of transmitters can be multiplied by a first set of block modulation coefficients such as the elements of a Walsh code or other orthogonal code/sequence of length four (the samples of the first pilot block are multiplied by the first element of the orthogonal code and so forth). The second set of transmitters would utilize a second orthogonal sequence or block modulation code/sequence in a similar fashion, and so forth. The receiver would combine weighted channel estimates from the four pilot blocks with the weighting coefficients based on the orthogonal sequences to recover certain channel estimates while suppressing others. (Note that in FIG. 6, the block modulation coefficients are (1,1) for transmitters in the first set and (1,−1) for the transmitters in the second set). The weighting coefficients can be based on the block modulation coefficients (such as the conjugates of the block modulation coefficients) or be adapted based on channel conditions to provide a compromise between tracking any variation of the channel response over the burst and suppression of the interfering pilot signals from other transmitters. In one embodiment, the weighting coefficients are based on the block modulation coefficients and the Doppler frequency or expected channel variation over the burst thereby providing a tradeoff between channel tracking and interference suppression. The weighting coefficients may also be different for different positions (e.g., different data block positions) in the burst by selecting or determining a set of weighting coefficients to be used for processing the received pilot blocks at each position in the burst. The weighting coefficients can be based on an MMSE criteria. The processing may comprise filtering/interpolation based on the weighting coefficients. In cases where Rp is 2 or larger, the processing can be two-dimensional (frequency and time), or can be performed separately over frequency and then time, or for some channels with limited variation over the burst duration the two received pilot blocks can be treated as being received at the same time and a frequency interpolation/filtering can be performed on the composite of the occupied pilot subcarriers from the two received pilot blocks. In cases where the delay spread is less than the minimum increment between cyclic shifts (cyclic delays), the processing can be adapted to provide improved performance. In this case, the interference between transmitters will be suppressed within each pilot individually, so the processing can select or determine the weighting coefficients based on the expected amount of channel variation and noise instead of determining or selecting weights that are designed to suppress pilot interference over the multiple pilot blocks.

In another embodiment with more than two pilot blocks, the sets of orthogonal block modulation codes may be applied independently over a several subsets of the pilot blocks to allow for frequency hopping of the data and/or pilot transmission and/or large channel variations. For the example of 4 pilot blocks it is to be noted that a pair of length-4 orthogonal Walsh codes (1, 1, 1, 1) and (1, −1, 1, −1) can be selected as the possible block modulation codes over the 4 pilots block such that the result is the equivalent of the described pair-wise length-2 Walsh coding over two consecutive pilot blocks.

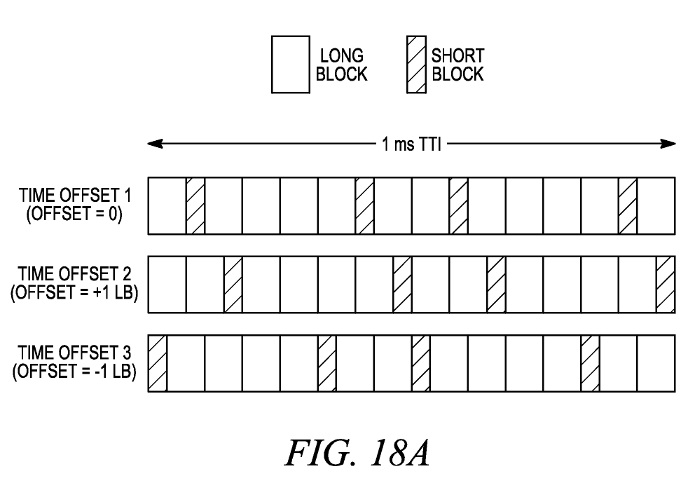

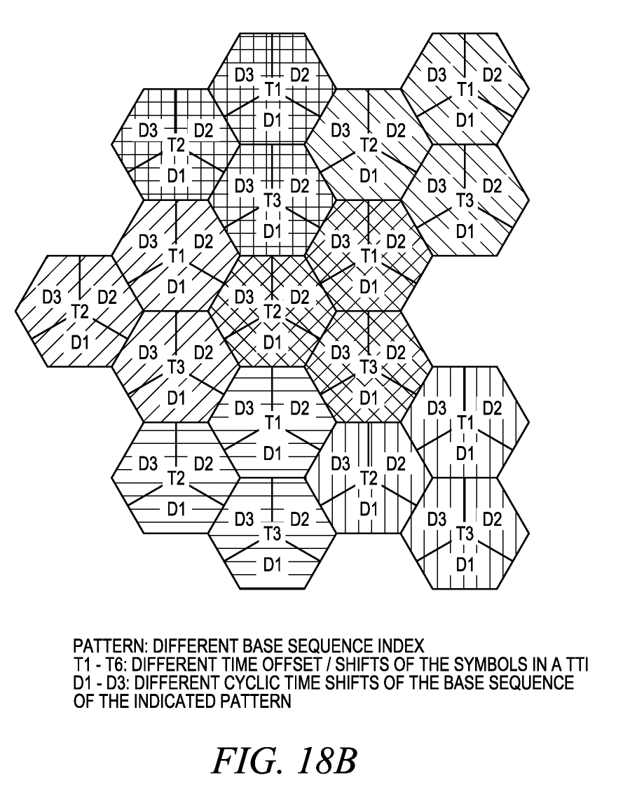

Orthogonal code hopping: In another embodiment, a first orthogonal block modulation coefficeints/sequence is used by a set of transmitters in a first burst/sub-frame over a first plurality of pilot blocks and a different second orthogonal block modulation coefficient/sequence is used by the set of transmitters in a second burst/sub-frame over a second plurality of pilot blocks. For example with respect to the transmission format in FIG. 18A consisting of two sub-frames with four pilot blocks, a first set of transmitters use orthogonal block modulation coefficients (1,1) over the first and second pilot blocks in the first burst, or sub-frame, and (1,−1) block modulation coefficients over first and second pilot blocks in a second burst, or sub-frame, while a second set of transmitters use orthogonal block modulation coefficients (1,−1) over the first and second pilot blocks in the first burst, or sub-frame and (1,1) block modulation coefficients over the first and second pilot blocks in the second sub-frame. The orthogonal sequence used in a burst/sub-frame (or the orthogonal sequence index offset from the orthogonal sequence index in a previous burst/sub-frame) may be a function of the pilot block location within the sub-frame, sector/cell identification ID, sub-frame number, system frame number or a combination thereof.

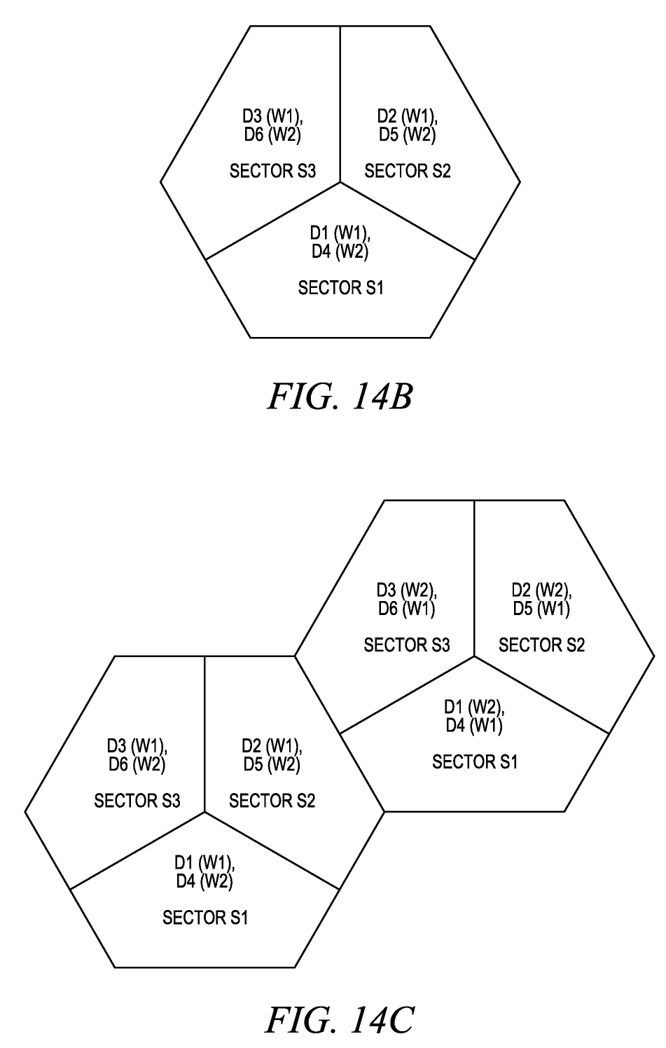

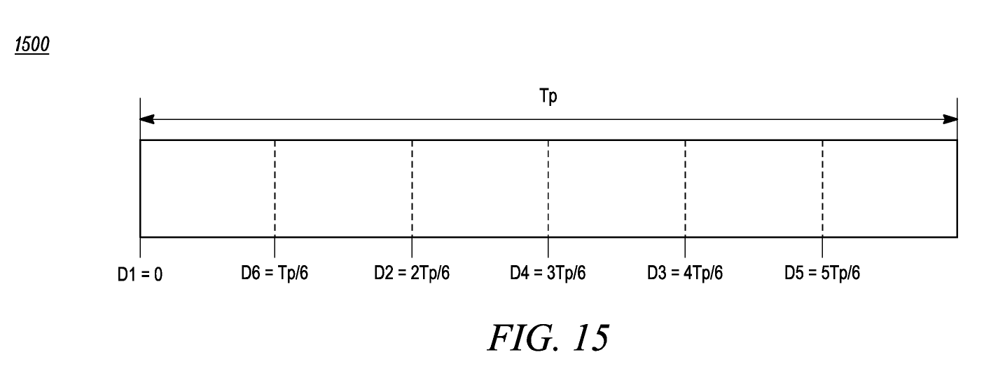

In another embodiment, the cyclic shifts and/or the orthogonal block modulation sequences may be used across sectors (served by different base units) to improve the edge-of-sector performance. By using cyclic shifts and/or the orthogonal block modulation sequences across sectors can enable coherent channel estimation of dominant interferer, joint detection or other interference cancellation between sectors. This embodiment is illustrated in FIG. 14 where a single frequency cell with 3 sectors labeled S1, S2, and S3 is depicted. In this example, up to six cyclic time shifts, D1=0, D2=Tp/6, D3=2Tp/6, D4=3Tp/6, D5=4Tp/6, D6=5Tp/6, of a base pilot sequence with cyclic time shift increment of Tp/6 can be assigned to transmitters as shown in FIG. 15. However, in this example the pilots or channel estimate separability at the receiver is limited to 3 transmitters on a pilot block (i.e., with no orthogonal block modulation across pilot blocks) as the expected maximum channel response duration is larger than the cyclic time shift increment of Tp/6 but no larger than Tp/3. In FIG. 14A, a single cyclic time shift is used by transmitters in each sector with cyclic time shift D1 used in sector S1, cyclic time shift D2 in sector S2, and cyclic shift D3 in sector S3. In addition, as explained above, orthogonal block modulation codes may be used when multiple transmitters in a sector are transmitting pilot blocks simultaneously on the same set of subcarriers using the same cyclic shift. The cyclic time shifts used among sectors are such that the shifts are maximally spaced (Tp/3), and give excellent edge-of-sector CE performance for both the desired and interfering signals. Thus, a first base unit is assigned a first set of cyclic time shifts of a first base pilot sequence and a second base unit is assigned a second set of cyclic time shifts of a second base pilot sequence wherein the cyclic time shifts in each of the first and second set of cyclic time shifts is approximately maximally spaced for the expected maximum channel response duration.

In FIG. 14B, one of two cyclic time shift are assigned to transmitters in each sector—cyclic time shift D1, D4 in sector S1, cyclic time shift D2, D5 in sector S2, and cyclic shift D3, D6 in sector S3. In addition, orthogonal block modulation codes may be used when multiple transmitters in a sector are transmitting pilot blocks simultaneously on the same set of subcarriers, for example when pilot transmissions occur simultaneously by two or more transmitters on the same set of subcarriers, such as mobile unit 203 and mobile unit 210, in case of SDMA or by two or more antennas of mobile unit 210 in case of MIMO. In one embodiment for the case of two pilot blocks, orthogonal block modulation code W1=(1,1) is used by transmitters using cyclic time shifts D1, D2, D3 and orthogonal block modulation code W2=(1, −1) is used by transmitters using cyclic time shifts D4, D5, D6 over the two pilot blocks. With this mapping, different cyclic time shift of the same orthogonal code is used by transmitters in different sectors with a spacing of Tp/3 corresponding to the expected maximum channel response duration in this example. Also, there is maximal spacing of Tp/2 between the cyclic time shifts of the SDMA/MIMO transmitters within a sector (e.g. cyclic time shift D1, D4 in sector S1) plus orthogonal block coding for double protection for suppression of the interfering pilot signals from other transmitters and improved averaging over other-cell interference. Thus, different cyclic time shifts are used with different orthogonal block codes to provide double protection. With SDMA/MIMO in each sector, there is still separation of Tp/6 between signals from different sectors (which is expected to provide better protection than using different base sequences in adjacent sectors) plus orthogonal block coding between each transmitter signal and its nearest two Tp/6 neighbors (each of which originates from a different sector, and hence it is unlikely that both will be present simultaneously).

The example in FIG. 14B is shown for a single cell. However, if a second cell uses the same base sequence, the second cell could use the same mappings of cyclic shifts and orthogonal block coding, or modified mappings. For example, it may be advantageous for the second cell to reverse the orthogonal block codes used with cyclic time shifts D1, D2, D3 and cyclic time shifts D4, D5, D6 relative to the first cell (e.g., in the second cell we have orthogonal code W2=(+1,−1) for transmitters using cyclic time shifts D1, D2, D3 and orthogonal code W1=(+1,+1) for transmitters using cyclic time shifts D4, D5, D6 as shown in FIG. 14C for the case when the second cell is adjacent to the first cell. This is beneficial in the case of non-MIMO/non-SDMA operation, when either only cyclic time shifts D1, D2, D3 or cyclic time shifts D4, D5, D6 are assigned to transmitters, and thus by reversing the orthogonal codes among cells further interference suppression benefit is achievable between the pilot signals transmitted by transmitters in the different cells. Since MIMO/SDMA transmission may be used less frequently than single antenna transmission, an overall system benefit may be obtained using this method.

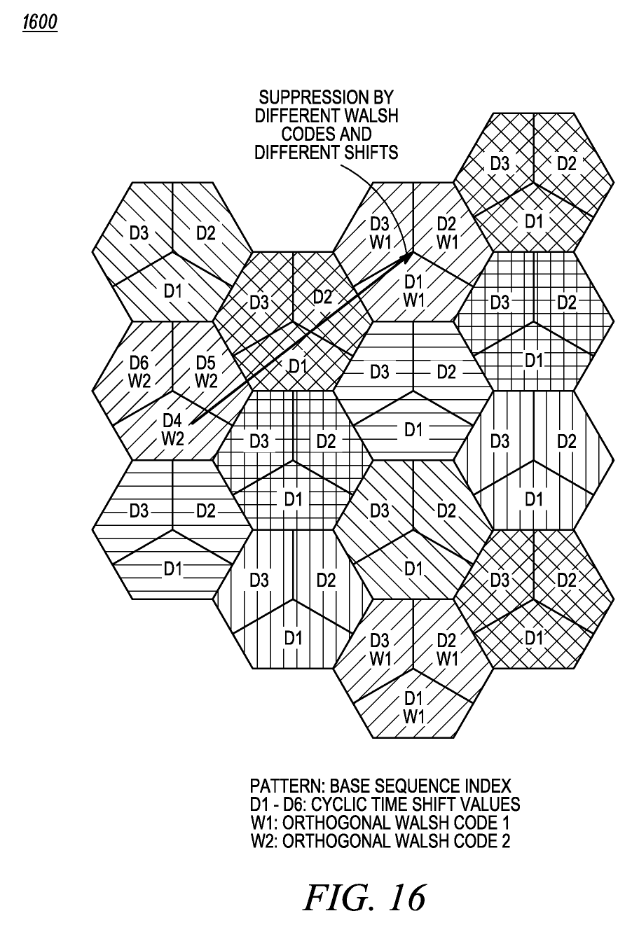

The number of base sequences with desirable sequence properties (e.g., constant modulus signal in frequency-domain, good auto and cross-correlation, good peak-to-average power ratio etc.) may be limited depending on the number of pilot subcarriers on the pilot blocks for a given transmission bandwidth. For example, in FIG. 5C, 6 pilot subcarriers are used by the two transmitters which may limit the number of base sequences to 6 for the case where the base sequences are generated from truncating a length-7 GCL sequence. The small number of base sequence may limit the sequence re-use plan and can result in significantly increased levels of interference. Thus, it may be beneficial to use the cyclic time shifts of the same base sequence across different cells and increase the number of pilot sequences available for example sequence planning or sequence hopping etc. This embodiment is illustrated in FIG. 16 where the cells with the same pattern correspond using the same base sequence. The cyclic time shifts (D1, D2, D3, D4, D5, and D6) and orthogonal codes (W1, W2 over two pilot blocks in this example) used by transmitters in the different sectors are also indicated. In this embodiment when MIMO/SDMA is not active, the cyclic time shifts that would normally be used to support it can be allocated to a different cells, to increase the number of sequences available for sequence planning (or for sequence hopping, etc.) For example, for the cyclic time shift values and orthogonal coding as in FIG. 14B, cell 1 uses cyclic time shifts D1, D2, D3 and orthogonal code W1 while cell 2 uses cyclic time shifts D4, D5, D6 and orthogonal code W2. Thus the interference in cell 1 from transmitters signals in cell 2 is suppressed by using different orthogonal shifts and also different cyclic time shifts. Although shown in FIG. 16, in general it is not required that the sector pointing directions be the same for the cell 1 and cell 2. Also note that in general it is not required that a particular cell uses the same orthogonal code in every sector. However, the orthogonal codes and/or delays among different cells should preferably be coordinated such that sectors pointing in the same direction use different orthogonal codes and/or different cyclic time shift values.

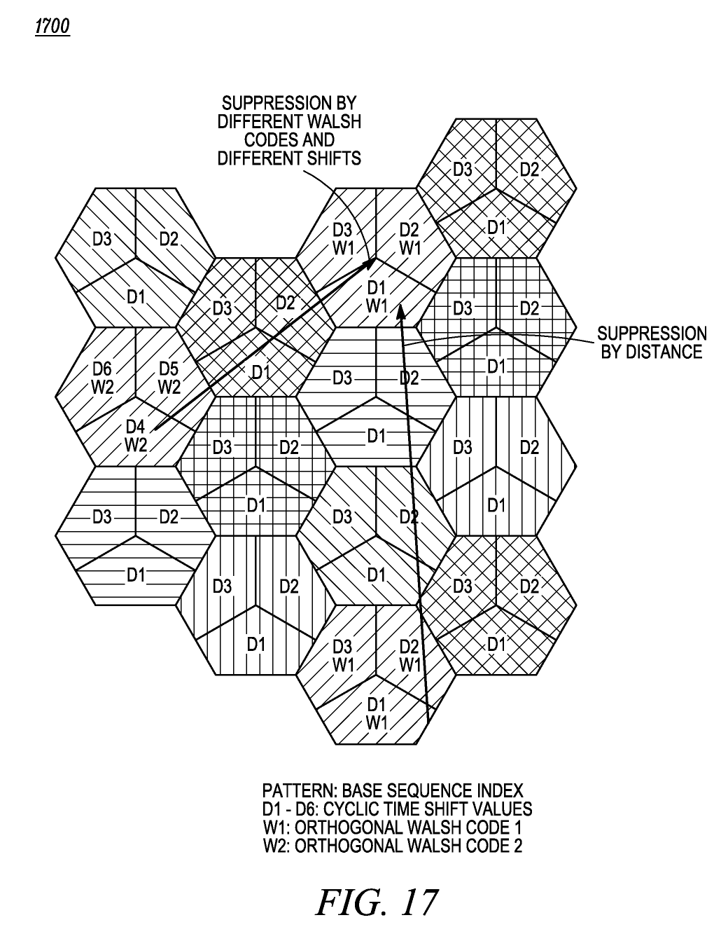

In another embodiment, different cells use the same base sequence and cyclic time shifts values but different orthogonal codes. This is illustrated in FIG. 17 where the cells with the same pattern correspond using the same base sequence and he cyclic time shifts (D1, D2, D3) and orthogonal codes (W1, W2 over two pilot blocks in this example) used by in the different sectors are indicated. the sector orientation of each yellow cell could be independently specified, if desired. In general, the sector orientation of each cell using the same base sequence could be independently specified. Additionally, two cells using the same base sequence could be placed adjacent to each other in the reuse plan, if desired (different reuse plan than is illustrated in FIG. 17).

In another embodiment the embodiments described may be combined with pilot sequence hopping which includes base pilot sequence hopping, cyclic time shift hopping, orthogonal code hopping and their combination thereof. Pilot sequence hopping may possibly reduce/alleviate the need for strict sequence reuse planning. With sequence hopping, a sector may change the sequence it uses, over time, for the pilot signals on one or more of pilot blocks. Cyclic shift hopping can be performed within a set of cyclic time shifts such as cyclic time shift set (D1, D2, D3) and cyclic time shift set (D4, D5, D6) that use the same orthogonal block code. The proposed methods can be used to create a larger pool of sequences with different base sequences, cyclic time shifts and/or orthogonal code for use in a sequence hopping scheme. Some methods can provide a fixed, known number of additional sequences in the pool of sequences available for hopping. Others, such as dynamically allocating particular cyclic time shifts between MIMO/SDMA use and for use among different sectors or different cells can create a dynamically varying pool of sequences for sequence hopping.

In another embodiment, to reduce/alleviate the need for strict sequence reuse planning and possibly provide further interference randomization, the pilot blocks in a burst/sub-frame may be staggered in different neighbor cells. This is illustrated in FIG. 18 where a TTI (Transmission Time Interval) of 1 ms consists of two bursts/sub-frames with 4 pilot blocks and 12 data blocks in a TTI. In this embodiment, a set of time offsets is defined for blocks in the TTI so that a pilot block (shown shaded, denoted short block, SB) of one cell (or Node-B or base station) overlaps with a data block (denoted long block, LB) of another cell (or Node-B or base station). The time offsets can be defined in a unique way that preserves the desirable properties of the radio frame timing, TTI format and sub-frame format. This can be accomplished by changing the data block and pilot block positions within the fixed TTI boundaries. In FIG. 18A an example of this embodiment with 3 time offsets (circular) is shown which effectively triples the number of allocable pilot resources from reuse perspective. Note that in this example the time boundaries (start time, end time) of the TTI are not changed, since the data block and pilot block positions are changed within the fixed TTI boundaries. For simplicity and consistency, the preferred approach is to time shift/offset all of the pilot block positions uniformly by either 0 LB, −1 LB, or +1LB. This results in the same sub-frame format (i.e., same positions of SBs and LBs) for both of the sub-frames that comprise a TTI. This can provide a consistent structure for channel estimation in each Node-B (e.g., number of LBs between each pilot SB block is kept constant and for all time offsets).

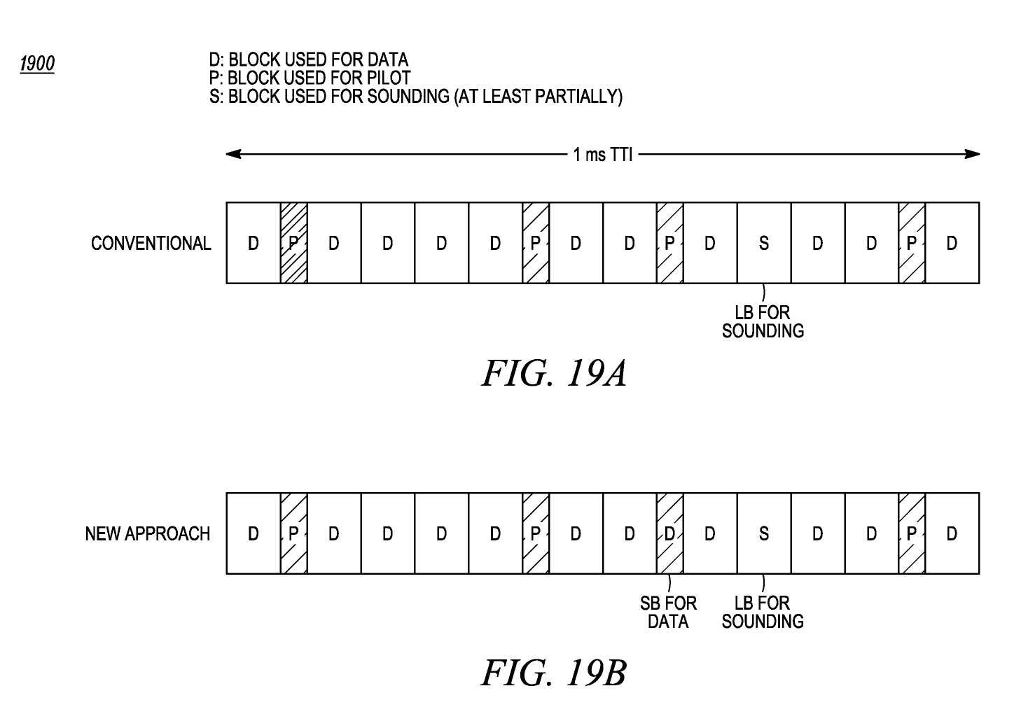

In another embodiment, one or more transmitters further transmit a pilot signal on a data block on a subset or all of the subcarriers to sound the channel and provide channel quality information to the base units for channel dependent scheduling. This pilot signal is often referred in the art as a sounding pilot signal. In this embodiment when a transmitter transmits the sounding pilot signal on at least a portion of the subcarriers used on the data blocks, then to reduce channel sounding overhead, one of the pilot blocks can be utilized for data transmission. This is illustrated in FIG. 19. In FIG. 19A the conventional prior art method is shown where at least a portion of a data block (denoted long block, LB) is used for the sounding pilot signal in addition to all of the pilot blocks in the TTI (In this example a TTI consists of two bursts/sub-frames with 4 pilot blocks and 12 data blocks with a data block used for the sounding pilot.) FIG. 19B shows the embodiment approach wherein a transmitter uses one of the pilot blocks to transmit data when a data LB block is used for sounding. The motivation for doing this is that typically channel dependent scheduling is used for low speed transmitters and thus using one of the pilot blocks for data should cause only minimal degradation in channel estimation performance. This does not impact other transmitters whose pilot blocks are FDMA using a different set of subcarriers for pilot transmission.

For the convenience, the embodiments of the invention are described for the case where a single frequency 1-cell, 3-sector, 1-sequence (1,3,1,) reuse plan—sectors labeled S1, S2, and S3 utilize the same base sequence. However, the invention and assignment principles are also applicable for different sequence reuse plans such as a 1-cell, 3-sector, 3-sequence (1,3,3,) reuse plan wherein the sectors utilize different base sequences.

In another embodiment, the pilot blocks are further modulated by a possibly complex QAM symbol (such as a symbol from BPSK, QPSK, 16-QAM, 64-QAM etc.). If an orthogonal block modulation code is used over a plurality of pilot blocks, the same orthogonal block code is also applied to the complex QAM symbol. Alternatively, the pilot blocks are first modulated by the same complex QAM symbol prior to applying the orthogonal block modulation codes over the pilot blocks.

In FIG. 14C, FIG. 16, FIG. 17, FIG. 18, FIG. 19 it is assumed that the it is assumed that all base units (sectors) and possibly base stations (cell) within system 200 are synchronized (for example, to a common time base) so that their frame periods are at least roughly aligned. This time synchronization maximizes the effectiveness of the techniques described. In an alternate embodiment, however, asynchronous cells may utilize the present invention even though the techniques described may be less sensitive to the use of asynchronous cells.

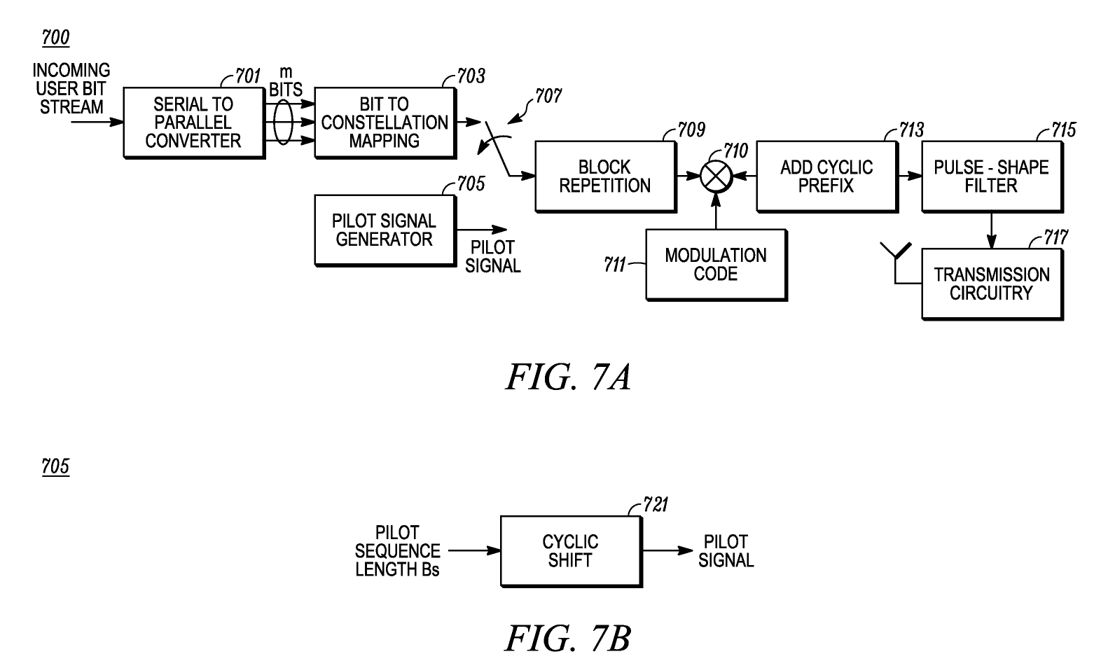

FIG. 7 is a block diagram of IFDMA transmitter 700 performing time-domain signal generation. During operation incoming data bits are received by serial to parallel converter 701 and output as m bit streams to constellation mapping circuitry 703. Switch 707 serves to receive either a pilot signal (sub-block) from pilot signal generator 705, or a data signal (sub-block) from mapping circuitry 703 of sub-block length, Bs. The length of the pilot sub-block may be smaller or larger than that of the data sub-block. As shown in FIG. 7B, pilot signal generator 705 may provide a cyclic time shift of a pilot sequence for the pilot sub-block. Regardless of whether pilot sub-block or data sub-block are received by sub-block repetition circuitry 709, circuitry 709 serves to perform sub-block repetition with repetition factor Rd on the sub-block passed from switch 707 to form a data block of block length B. Note that Rd=d can also be used, when the signal is to occupy a contiguous set of subcarriers thus providing a single-carrier signal. Block length B is the product of the sub-block length Bs and repetition factor Rd and may be different for pilot and data blocks, as was shown in FIG. 4. The sub-block length Bs and repetition factor Rd may be different for the data and pilot. Data block and a modulation code 711 are fed to modulator 710. Thus, modulator 710 receives a symbol stream (i.e., elements of data block) and a IFDMA modulation code (sometimes referred to as simply a modulation code). The output of modulator 710 comprises a signal existing at certain evenly-spaced frequencies, or subcarriers, the subcarriers having a specific bandwidth. The actual subcarriers that signal utilizes is dependent upon the repetition factor Rd of the sub-blocks and the particular modulation code utilized. The sub-block length Bs, repetition factor Rd, and modulation code can also be changed over time. Changing the modulation code changes the set of subcarriers, so changing the modulation code is equivalent to changing Sd. Varying the block length B, varies the specific bandwidth of each subcarrier, with larger block lengths having smaller subcarrier bandwidths. It should be noted, however, that while changing the modulation code will change the subcarriers utilized for transmission, the evenly-spaced nature of the subcarriers remain. Thus, subcarrier changing pilot pattern is achieved by changing the modulation code. In one embodiment of the present invention the modulation code is changed at least once per burst. In another embodiment, the modulation code is not changed in a burst. A cyclic prefix is added by circuitry 713 and pulse-shaping takes place via pulse-shaping circuitry 715. The resulting signal is transmitted via transmission circuitry 717.

Transmitter 700 is operated so that transmission circuitry 717 transmits a plurality of data symbols over a first plurality of subcarriers, each subcarrier within the first plurality of subcarriers has a first bandwidth. One example of this is the like shaded subcarriers between t1 and t2 in FIG. 5, the like shaded subcarriers between t3 and t4, and the shaded subcarriers beginning at t5. Transmission circuitry 717 transmits a first pilot sequence at a first time for a user, the first pilot sequence is transmitted in a first pattern over a second plurality of subcarriers. Each subcarrier from the second plurality of subcarriers has a second bandwidth. One example of this with the second bandwidth being different than the first bandwidth is the shaded subcarriers in the column Pilot Block 1 of FIG. 5 (between t2 and t3). The second pilot sequence is transmitted for the user at a second time. The second pilot sequence is transmitted in a second pattern over a third plurality of subcarriers, each subcarrier from the third plurality of subcarriers having a third bandwidth. One example of this with the third bandwidth being the same as the second bandwidth is the shaded subcarriers in the column Pilot Block 2 of FIG. 5 (between t4 and t5). Note that although the cyclic shift of the pilot sequence is shown to take place at the pilot signal generator 705, in other embodiments the cyclic shift of the pilot block could be implemented in other places. For example, a cyclic time shift can be applied to the pilot block samples between application of the modulation code (710) and the addition of the cyclic prefix (713).

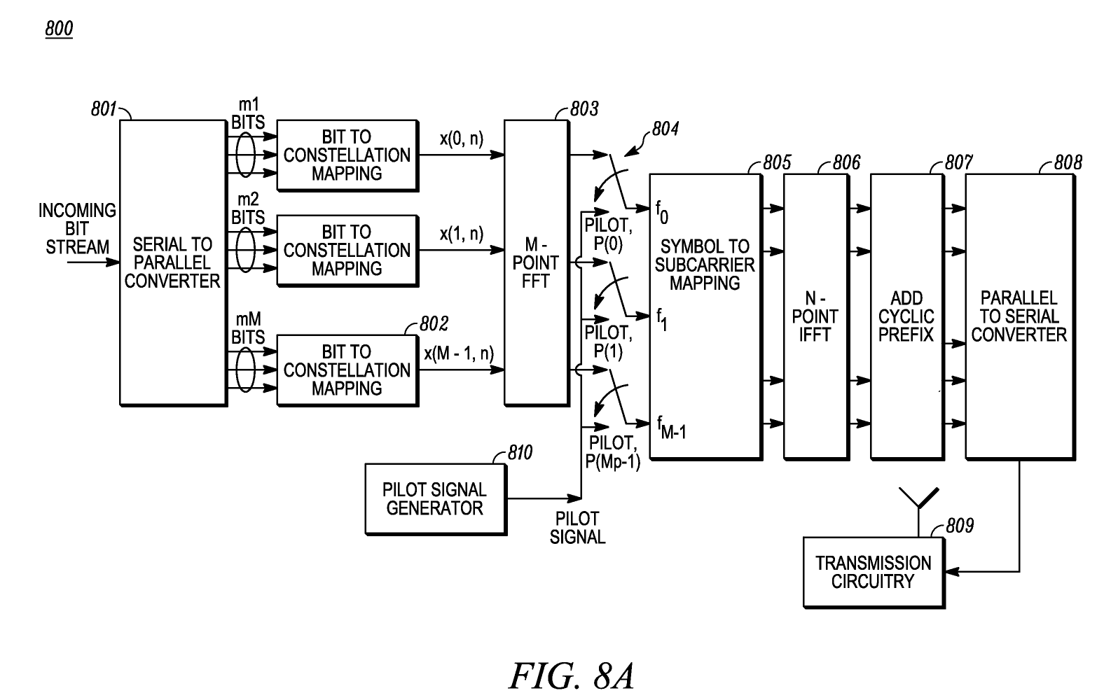

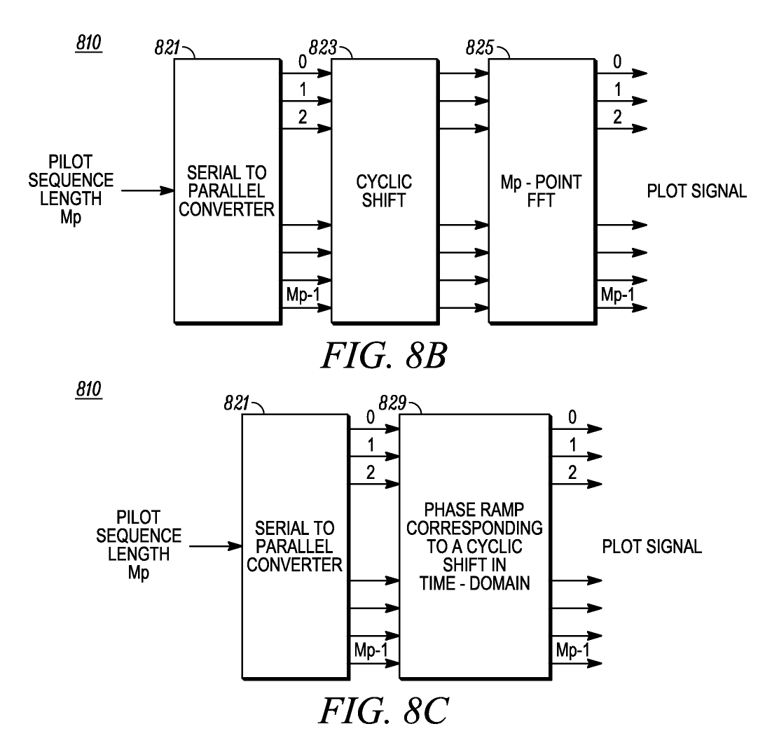

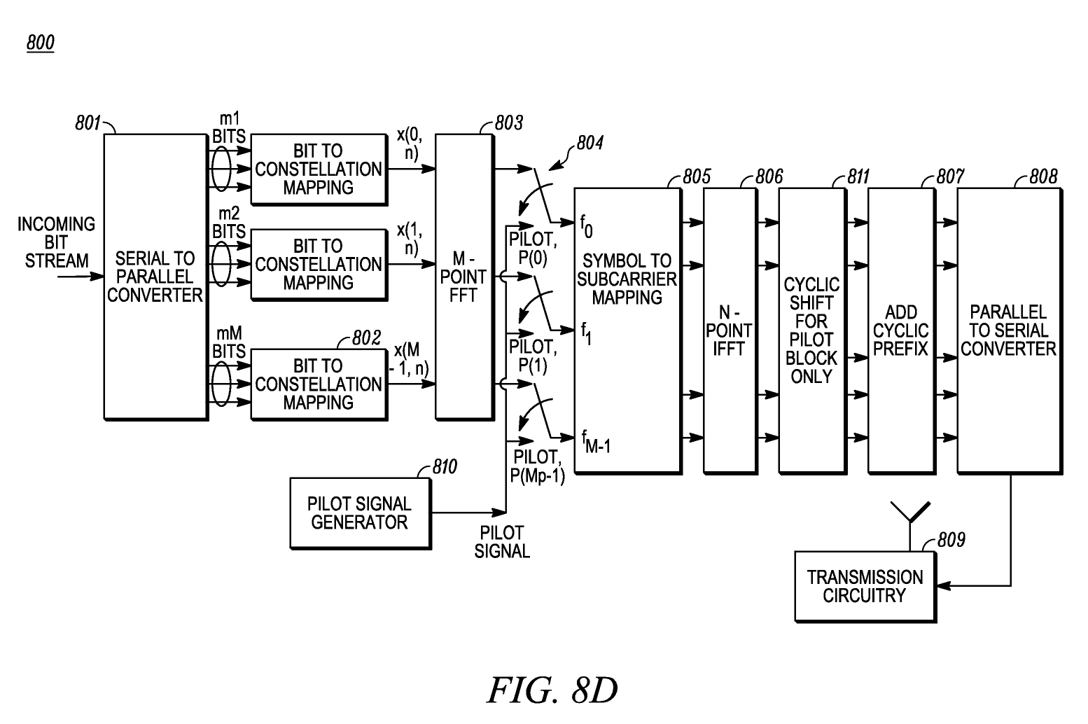

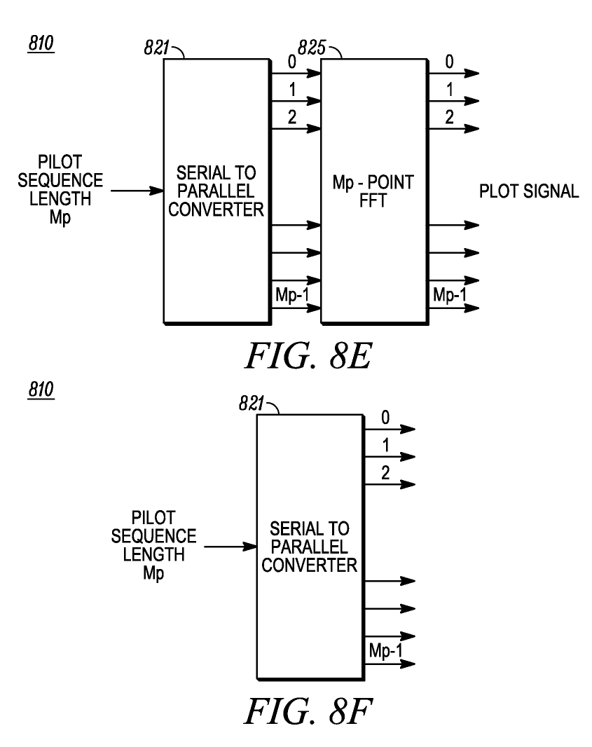

FIG. 8 is a block diagram of transmitter 800 (which will be designated as transmitter l in the following equations) used to transmit pilots and data in the frequency domain using a DFT-SOFDM transmitter. Blocks 801, 802, and 806-809 are very similar to a conventional OFDM/OFDMA transmitter, while blocks 803 and 805 are unique to DFT-SOFDM. As with conventional OFDM, the IDFT size (or number of points, N) is typically larger than the maximum number of allowed non-zero inputs. More specifically, some inputs corresponding to frequencies beyond the edges of the channel bandwidth are set to zero, thus providing an oversampling function to simplify the implementation of the subsequent transmission circuitry, as is known in the art. As described earlier, different subcarrier bandwidths may be used on pilot blocks than on data blocks, corresponding to different pilot block and data block lengths. In the transmitter of FIG. 8, different subcarrier bandwidths can be provided by different IDFT sizes (N) for pilot blocks and data blocks. For example, a data block may have N=512, and the number of usable subcarriers within the channel bandwidth may be B=384. Then, an example of a pilot block having a larger subcarrier bandwidth (and more specifically, a subcarrier bandwidth twice as large as a data block) is obtained by using N=512/2=256 for the pilot block, with the number of usable pilot subcarriers then being B=384/2=192. (Note that the example in FIG. 5 has a number of usable data subcarriers of 40, and a number of usable pilot subcarriers of 20.) The specific set of subcarriers out of the usable ones that are occupied by a data block or a pilot block are determined by the mapping block 805.

In the pilot signal generator block 810 the frequency-domain pilot symbols are generated and are fed to the symbol to subcarrier mapping block 805. As mentioned above, in one embodiment the frequency-domain pilot symbols for transmitter % are given as (for Rp=1 and 0≦k≦Mp−1 and b denotes the symbol where the pilot symbols are located): xₗ(k,b)=s(k,b)e^{-j2πkα}^{ₗ}^{/P} where s(k,b) is a baseline or un-shifted pilot sequence (e.g., a constant modulus signal such as QPSK a CAZAC sequence, a GCL sequence, or the DFT/IDFT of a CAZAC or GCL sequence), αₗ is the cyclic time shift for transmitter l and P is a cyclic shift factor. As mentioned above the sequence can be generated either in the time or frequency domains. More details of the pilot signal generator 810 for time-domain generation of the pilot symbols are given in FIG. 8B. As can be seen, the time-domain pilot sequence of length Mp, S(n,b), is first converted from serial to parallel 821 and then a circular cyclic shift is applied 810 (i.e., the values are circularly shifted by αₗ samples if P=Mp). Then in 825 a Mp-point FFT is applied to give the frequency-domain pilot symbols xₗ(k,b). As an alternative to time-domain generation of the pilot symbols, the pilot symbols can be generated directly in the frequency domain as shown in FIG. 8C. In this case the frequency-domain pilot sequence, s(k,b) is fed into the serial to parallel converter 821 and then a phase ramp is applied 829 which corresponds to the appropriate time shift and is given by the multiplication by the exponential term in the preceding equation.

A cyclic prefix is added by circuitry 807 followed by a parallel to serial converter 808. Also, although not shown, additional spectral shaping can be performed on the DFT-SOFDM signal to reduce its spectral occupancy or reduce its peak-to average ratio. This additional spectral shaping is conveniently implemented by additional processing before IDFT 806, and may for example be based on weighting or overlap-add processing. Finally the signal is sent over the RF channel through use of transmission circuitry 809.

In FIG. 8D a time-domain implementation of DFT-SOFDM transmitter (denoted as transmitter l in the following equations) is given where the cyclic shift for the pilot block only is applied in the time domain. This embodiment may have implementation advantages since a time-domain cyclic shift is low complexity and thus the multiplication by a phase ramp (i.e., the exponential term in the pilot symbol equations or block 829 in FIG. 8C) is avoided as is the Mp-point IFFT (block 825 in FIG. 8B). Note the cyclic shift in 811 is not applied to data blocks. Only the blocks that are not common to FIG. 8A are now explained. The time-domain pilot symbol generation 810 is described in FIG. 8E. In this embodiment of the pilot signal generator 810, the time-domain pilot sequence, S(n,b), goes through a serial to parallel converter 821 and then an Mp-point FFT is taken to generate the frequency-domain pilot symbols. An alternative to the time-domain pilot signal generator 810 for the transmitter in FIG. 8D is the frequency-domain pilot signal generator given in FIG. 8F. In this embodiment, the frequency-domain pilot sequence, s(k,b) is only serial to parallel converted 821 to generate the pilot symbols. In both embodiments of the pilot signal generator, the cyclic shift for the pilot blocks is generated by performing a circular time shift 811. In one embodiment assume that the desired frequency-domain pilot sequence is given as (for Rp=1 and 0≦k≦Mp−1 and b denotes the symbol where the pilot symbols are located): xₗ(k,b)=s(k,b)e^{-j2πkα}^{ₗ}^{/P} where s(k,b) is a baseline or un-shifted frequency-domain pilot sequence (e.g., a constant modulus signal such as QPSK, a CAZAC sequence, a GCL sequence, or the DFT/IDFT of a CAZAC or GCL sequence), αₗ is the cyclic time shift for transmitter l and P is a cyclic shift factor. Then the time-domain shift of αₗ samples would be applied to the time-domain samples received by block 811 (assuming P=Mp).

In one embodiment of the invention, a transmitter (e.g., as shown in FIG. 7 and FIG. 8) receives a resource allocation message, and determines pilot configuration information based on the received resource allocation message. The pilot configuration information may comprise cyclic time shift information for a first pilot block and a second pilot block, and block modulation coefficient information for the pilot blocks, and possibly information specifying the baseline or un-shifted pilot sequence. There are various ways the pilot configuration information can be provided based on the resource allocation message. For example, the pilot configuration information can be directly specified in the message, or the pilot configuration information may be implicitly specified based on other information in the resource allocation message and predetermined mapping rules. An example of implicit specification is that the message specifies the resources to be used for data transmission (e.g., (Td,Rd,Sd) and a center frequency) by a transmitter, and there is a predetermined mapping between each possible data resource allocation and the pilot configuration information. Note that the pilot configuration information could also be specified with a combination of direct and implicit information from the resource allocation message.

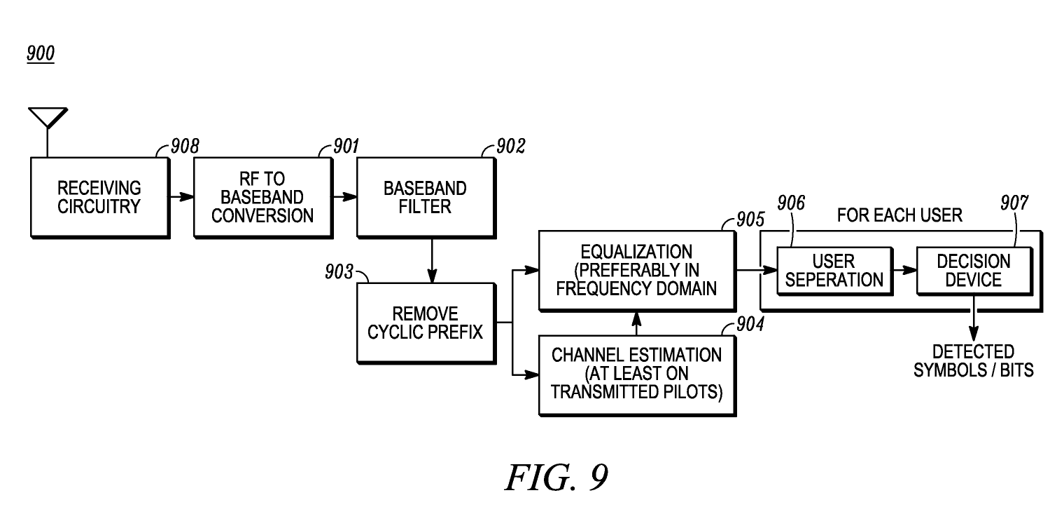

FIG. 9 is a block diagram of receiver 900. The received signal is a composite of the channel distorted transmit signal from all the transmitters. During operation the received signal is converted to baseband by baseband conversion circuitry 901 and baseband filtered via filter 902. Once pilot and data information are received, the cyclic prefix is removed from the pilot and data blocks and the blocks are passed to channel estimation circuitry 904 and equalization circuitry 905. As discussed above, a pilot signal is commonly used for communication systems to enable a receiver to perform a number of critical functions, including but not limited to, the acquisition and tracking of timing and frequency synchronization, the estimation and tracking of desired channels for subsequent demodulation and decoding of the information data, the estimation and monitoring of the characteristics of other channels for handoff, interference suppression, etc. With this in mind, circuitry 904 performs channel estimation on the occupied subcarriers for the data block utilizing at least received pilot blocks.

As described above, one embodiment of the channel estimator is the correlator given above. Assuming that the frequency-domain pilot sequence for the l^{th} transmitter on subcarrier k and symbol (block) b is given as (for Rp=1): xₗ(k,b)=s(k,b)e^{-j2πkα}^{ₗ}^{/P} where s(k,b) is a baseline or un-shifted pilot sequence (e.g., a constant modulus signal such as QPSK, a CAZAC sequence, a GCL sequence, or the DFT/IDFT of a CAZAC or GCL sequence), αₗ is the cyclic time shift for transmitter (for example assume that there are four transmitters and α₁=0, α₂=Tp/4, α₃=Tp/2, and α₄=3Tp/4), and P is a cyclic shift factor (for example, P=Tp). The channel estimator 904 correlates the original pilot sequence with the received pilot sequence with the cyclic prefix removed (i.e., the composite received pilot block from the four transmitters in the example) to get the time-domain channel estimates for each transmitter. In the example, the channel response to the first transmitter will be in a first block of Tp/4 correlator output samples (as also shown in FIG. 6 602 for this example), the channel response to the second transmitter will be in the next block of Tp/4 correlator output samples (as shown in FIG. 6 604), and so forth (as shown in FIG. 6 606 and 608).

The channel estimate is passed to equalization circuitry 905 so that proper equalization of the data blocks on the occupied subcarriers may be performed. The signal output from circuitry 905 comprises an appropriately equalized data signal that is passed to a user separation circuitry 906 where an individual user's signal is separated from the data signal (the transmission from a single user corresponds to a transmission from each transmitter at the user). The user separation can be performed in time-domain or frequency-domain and can be combined with the equalization circuitry 905. Finally decision device 907 determines the symbols/bits from the user-separated signal that were transmitter.

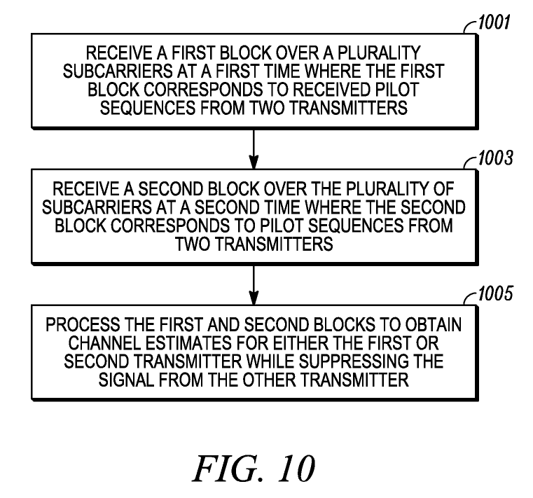

FIG. 10 shows a flow chart representation of an embodiment of a receiver (e.g., base station) that will determine channel estimates from one of two transmitters in accordance to the present invention. In block 1001 the receiver receives a first block over a plurality of subcarriers at a first time, wherein the first block comprises a first pilot sequence with a first time shift from a first transmitter and a second pilot sequence with a second time shift from a second transmitter. Then in block 1003, the receiver receives a second block over the plurality of subcarriers at a second time, wherein the second block comprises a third pilot sequence with a third time shift from the first transmitter and a fourth pilot sequence with a fourth time shift from the second transmitter, wherein the third time shift depends on the first time shift and the fourth time shift depends on the second time shift. Finally in block 1005, the receiver processes the first block and the second block to recover channel estimates for one of the first transmitter and the second transmitter, while suppressing the signal from the other transmitter.

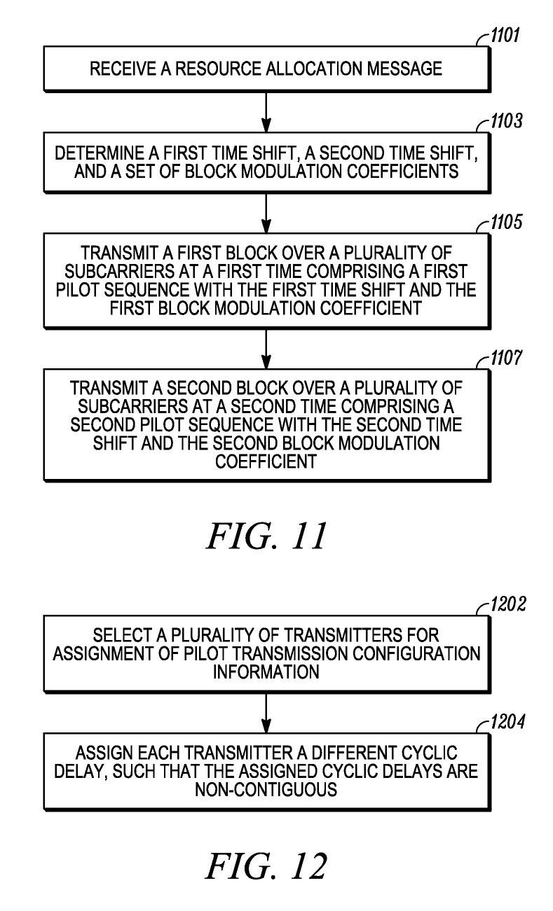

FIG. 11 shows a flow chart representation of an embodiment of a transmitter that will create a pilot sequence in accordance to the present invention. In block 1101, the transmitter receives a resource allocation message from the receiver that will receive the transmitter's pilot sequence. In block 1103, the transmitter determines, based on the resource allocation message, a first time shift, a second time shift, and a set of block modulation coefficients. Then in block 1105, the transmitter transmits a first block over a plurality of subcarriers at a first time, wherein the first block comprises a first pilot sequence with the first time shift and is multiplied by the first block modulation coefficient. Finally in block 1107, the transmitter transmits a second block over the plurality of subcarriers at a second time, wherein the second block comprises a second pilot sequence with the second time shift and is multiplied by the second block modulation coefficient, wherein the second time shift depends on the first time shift.

In an additional embodiment of the invention, each of a plurality of transmitters is assigned a different cyclic shift value from a set of cyclic delay values to be used for pilot transmission on a pilot block. The different cyclic delay values are chosen and assigned in a manner that increases the separability of the channel estimates of the transmitters at a receiver by increasing the spacing between the assigned cyclic shift values. Consider a system where the cyclic delay values available for assignment to transmitters are T0+k*T1, where k is a non-negative integer <=kmax. In one aspect of this embodiment, when the number of transmitters being assigned to transmit a pilot in a pilot block is less than kmax and greater than one, then the cyclic delay values (or values of k) assigned to the transmitters are non-contiguous. Non-contiguous means that there are at least two cyclic delay values that are not assigned to a transmitter, a first unassigned cyclic delay and a second unassigned cyclic delay, and that at least one cyclic delay (a third cyclic delay), which has a value between the first unassigned cyclic delay and the second unassigned cyclic delay is assigned to a transmitter. In addition, the cyclic delay values assigned to the transmitters are preferably maximally separated. For example, if there are four possible cyclic shift values of 0, T1, 2T1, and 3T1 in a pilot block of length 4T1 and two transmitters are being assigned to transmit in a pilot block, the separation between the assigned cyclic delays would be chosen as 2T1 to provide maximal separation (note that when the pilot block length is 4T1, the cyclic delay values of 0 and 3T1 are actually adjacent rather than maximally separated, since the cyclic delays are circular delays) first transmitter can be assigned a cyclic shift of 0 and the second transmitter can be assigned acyclic shift of 2T1. By assigning maximally separated cyclic delays to the transmitters, extra protection is provided against unexpected channel conditions, such as channels where the delay spread is longer than the difference between consecutive cyclic delays. A flow chart for this embodiment is shown in FIG. 12. In step 1202, a plurality of transmitters is selected for assignment of pilot transmission configuration information. Each of the plurality of transmitters is to be assigned a pilot transmission configuration. In step 1204, a different cyclic delay is assigned to each of the plurality of transmitters from a set of cyclic delays, for pilot transmission by each of the transmitters wherein the cyclic delays are assigned to the transmitters such that the assigned cyclic delay values are non-contiguous (not all contiguous). The non-contiguous assignment may further comprise leaving a first cyclic delay unassigned and a second cyclic delay unassigned, and may further comprise assigning at least one of the cyclic delays having a value between the first unassigned cyclic delay and the second unassigned cyclic delay to a transmitter. The method may further comprise assigning non-consecutive cyclic delays to two of the plurality of transmitters, where at least one of the two transmitters has a channel delay spread that exceeds the spacing between adjacent cyclic delay values of the set of cyclic delay values.

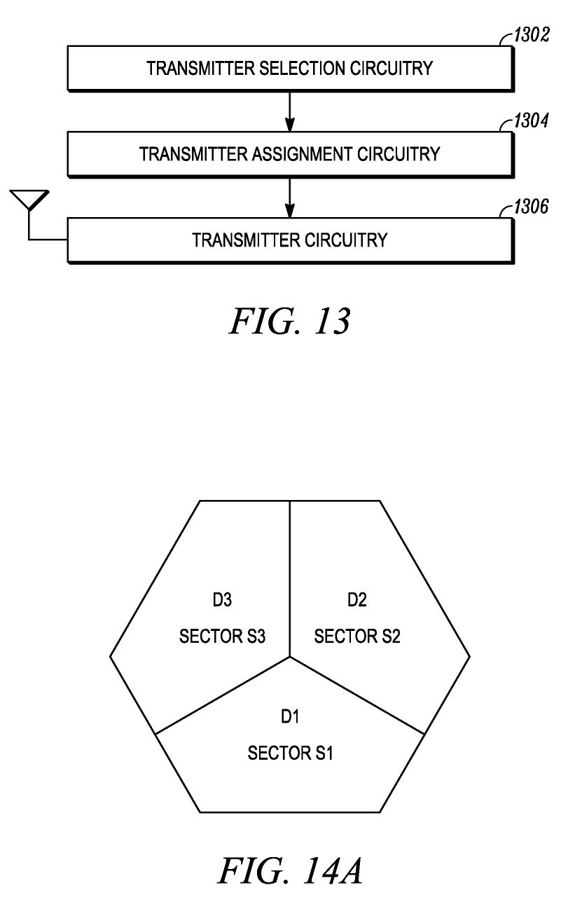

A block diagram of a controller unit in accordance with the embodiment of FIG. 12 is shown in FIG. 13. The controller unit 1300 includes transmitter selection circuitry 1302, for selecting a plurality of transmitters for assignment of pilot transmission configuration information, transmitter assignment circuitry 1304, for providing the cyclic delay assignment information, and transmitter circuitry 1306, for transmitting the assignment information. Controller unit 1300 may be embedded in a communication unit such as a base station, and is coupled to the transmitter of the communication unit to transmit the assignment information to the plurality of transmitters.

Although some embodiments of the present invention use the same block length and repetition factor (for IFDMA) or subcarrier mapping (for DFT-SOFDM) for each of the pilot blocks within a burst, alternate embodiments may use a plurality of block lengths and/or a plurality of repetition factors and/or subcarrier mappings for the plurality of pilot blocks within a burst. Note that different bock lengths provide different subcarrier bandwidths, which may further enhance the channel estimation capability.

The pilot configuration for a burst (e.g., the first or second configuration of FIG. 13) is preferably assigned by the base station dynamically based on channel conditions, such as the rate of channel variations (Doppler), but the assignment can be based on requests from the mobile unit, or on uplink measurements made by the base unit from previously received uplink transmissions. As described, the determination may be based on a channel condition such as Doppler frequency or on a number of antennas used for transmitting data symbols, and the determination can be made by the base unit, or by a mobile unit which then sends a corresponding request to the base unit. In systems with a scheduled uplink, the base unit can then assign the appropriate pilot format to the mobile unit for the subsequent transmissions from the mobile unit.

While the invention has been particularly shown and described with reference to a particular embodiment, it will be understood by those skilled in the art that various changes in form and details may be made therein without departing from the spirit and scope of the invention. It is intended that such changes come within the scope of the following claims.

What is claimed is:

1. A method for assigning pilot transmission configurations, comprising
assigning a first transmitter served by a first base unit a first cyclic time shift from a first set of cyclic time shifts of a first base pilot sequence,
assigning a second transmitter served by the first base unit a second cyclic time shift from a second set of cyclic time shifts of the first base pilot sequence,
assigning a third transmitter served by a second base unit a third cyclic time shift from the first set of cyclic time shifts of a second base pilot sequence,
assigning a fourth transmitter served by the second base unit a fourth cyclic time shift from the second set of cyclic time shifts of the second base pilot sequence,
wherein the first and second set of cyclic time shifts are subsets of a third set of cyclic time shifts and the cyclic time shifts in each of the first and second set of cyclic time shifts is such that the cyclic shift values are non-contiguous with approximately maximally spaced for the expected maximum channel response duration.

2. The method of claim 1, wherein the cyclic time shifts in both the first and second set of cyclic time shifts is not identical.

3. The method of claim 1 further comprising,
assigning the first transmitter a first block modulation sequence from a set of block modulation sequences,
assigning the second transmitter a second block modulation sequence from the set of block modulation sequences,
assigning the third transmitter a third block modulation sequence from the set of block modulation sequences, and
assigning the fourth transmitter a fourth block modulation sequence from the set of block modulation sequences.

4. The method of claim 3 wherein the first block modulation sequence is equal to the third modulation sequence and the second modulation sequence is equal to the fourth modulation sequence.

5. The method of claim 1 wherein the first transmitter uses the first cyclic time shift at a first time instance and the third cyclic time shift at a second time instance.

6. The method of claim 3 wherein the first transmitter uses the first block modulation sequence at a first time instance and the second block modulation sequence at a second time instance.

7. The method of claim 1 wherein the first transmitter uses the first base pilot sequence at a first time instance and the second base pilot sequence at a second time instance.

8. The method of claim 1 further comprising pilot transmission from the first transmitter and second transmitter occur over a same set of subcarriers.

9. The method of claim 1 wherein the first transmitter is a first user terminal and the second transmitter is a second user terminal.

10. The method of claim 1 wherein the first transmitter is a first antenna and the second transmitter is a second antenna, wherein the first and second antennas are on a user terminal.

11. The method of claim 1 wherein the third transmitter is a first user terminal and the fourth transmitter is a second user terminal served by the second base unit.

12. The method of claim 1 wherein the third transmitter is a first antenna and the fourth transmitter is a second antenna, wherein the first and second antenna are on a user terminal served by the second base unit.

13. The method of 1 wherein non-contiguous cyclic time shifts in the first and second set of cyclic time shifts comprises leaving a first cyclic time shift unassigned and a second cyclic time shift unassigned from the third set of cyclic time shifts, and further comprises including at least one of the cyclic time shifts from the third set having a value between the first unassigned cyclic time shift and the second unassigned cyclic time shift.

14. The method of claim 1 wherein the spacing between adjacent cyclic delay values of the third set of cyclic time shift values exceeds the is at least one of the two transmitters has a channel delay spread that exceeds the expected maximum channel response duration.

15. The method of claim 3 wherein the set of block modulation sequences is a set of orthogonal sequences.

16. A method for pilot transmission, the method comprising the steps of:
receiving a resource allocation message;
determining, based on the resource allocation message, a first time shift, a second time shift, a third time shift, a fourth time shift and a first block modulation sequence, and a second block modulation sequence,
transmitting a first block over a first plurality of subcarriers at a first time, wherein the first block comprises a first pilot sequence with the first time shift using the first block modulation sequence; and
transmitting a second block over the first plurality of subcarriers at a second time, wherein the second block comprises a second pilot sequence with the second time shift using the first block modulation sequence, wherein the second time shift depends on the first time shift,
transmitting a third block over a second plurality of subcarriers at a third time, wherein the third block comprises a third pilot sequence with the third time shift using the second block modulation sequence; and
transmitting a fourth block over the second plurality of subcarriers at a second time, wherein the fourth block comprises a fourth pilot sequence with the fourth time shift using the second block modulation sequence, wherein the fourth time shift depends on the third time shift.

17. The method of claim 16 wherein the first pilot sequence is equal to the second pilot sequence and the third pilot sequence is equal to the fourth pilot sequence.

18. The method of claim 16 wherein the first block modulation sequence is equal to the second block modulation sequence.

19. The method of claim 16 wherein the first time shift is equal to the third time shift.

20. The method of claim 16 wherein the second time shift is equal to the first time shift.

21. The method of claim 16 wherein the first plurality of subcarriers is equal to the second plurality of subcarriers.

22. The method of claim 16 wherein the set of block modulation sequences is a set of orthogonal sequences.

22. The method of claim 16 wherein the first and second blocks are the first and second blocks of a first burst.

23. The method of claim 22, wherein the third and forth blocks are the first and second blocks of a second burst.
